(19) United States
(12) Patent Application Publication
(10) Pub. No.: US 2012/0185693 A1
(43) Pub. Date: Jul. 19, 2012

(54) SECURE PROGRESSIVE DOWNLOAD FOR MEDIA CONTENT PLAYBACK

(75) Inventors: Kuang M. Chen, San Diego, CA (US); Jiang Zhang, San Diego, CA (US)

(73) Assignee: GENERAL INSTRUMENT CORPORATION, Horsham, PA (US)

(21) Appl. No.: 13/344,000

(22) Filed: Jan. 5, 2012

Related U.S. Application Data
(60) Provisional application No. 61/429,920, filed on Jan. 5, 2011.

(51) Int. Cl. H04L 9/28

(52) U.S. Cl. 713/168

(57) ABSTRACT

In embodiments of secure progressive download for media content playback, a client device (128) implements a media player (142) and a proxy application (144). The proxy application is implemented to receive media content (136) from a media server (126), and the media player controls playback of media content (148) on the client device. The proxy application receives the media content (136) encrypted and formatted by the media server for playback by the media player, and the proxy application initiates storing segments of the media content (148) as encrypted media content on the client device. The proxy application also requests an encryption key (124) to decrypt the encrypted media content for playback by the media player. The proxy application receives the encryption key from a key server (122) and stores the encryption key on the client device to decrypt the encrypted media content when requested by the media player.

### RELATED APPLICATIONS

This application claims priority to U.S. Provisional Application Ser. No. 61/429,920 filed Jan. 5, 2011, entitled “Secure Progressive Download”, the disclosure of which is incorporated by reference herein in its entirety.

### BACKGROUND

The traditional notion of watching television at home has evolved into many different forms of viewing television content, on many different devices. For example, users can watch television content, such as live television, recorded television, and time-shifted programs and movies, on various devices, such as televisions, display devices, entertainment devices, computers, and even mobile devices, such as tablets and mobile phones. Media content that is streamed or otherwise communicated to a client device, such as media content wirelessly communicated to a mobile phone, needs to be maintained as secure and encrypted. However, current mobile phones are not typically implemented to decrypt the media content that is encrypted by some security systems for playback as a progressive download, and further, current mobile phones are not able to render high-definition media content. Thus, a user that records a television program or movie in high-definition with a digital video recorder (DVR) can not then transfer the high-definition media content to a mobile phone for playback at the user's convenience, such as when the user may be traveling or not communicatively linked in a home network.

### BRIEF DESCRIPTION OF THE DRAWINGS

Embodiments of secure progressive download for media content playback are described with reference to the following Figures. The same numbers may be used throughout to reference like features and components that are shown in the Figures:

FIG. 1 illustrates an example system in which embodiments of secure progressive download for media content playback can be implemented.

FIG. 2 illustrates an example software stack for a client device in embodiments of secure progressive download for media content playback.

FIG. 3 illustrates an example client device API object model in embodiments of secure progressive download for media content playback.

FIG. 4 illustrates example method(s) of secure progressive download for media content playback in accordance with one or more embodiments.

FIG. 5 illustrates example method(s) of secure progressive download for media content playback in accordance with one or more embodiments.

FIG. 6 illustrates various components of an example electronic device that can implement embodiments of secure progressive download for media content playback.

FIG. 7 illustrates an example of client device registration state transitions in accordance with one or more embodiments.

FIGS. 8-18 illustrate API object model communication sequence diagrams between the components, devices, and entities in a domain system in accordance with one or more embodiments.

### DETAILED DESCRIPTION

In embodiments, secure progressive download for media content playback can be utilized to deliver encrypted media content to a client device, such as a mobile phone, tablet device, or portable computer, for playback by a media player that controls playback of the media content on the client device. Secure media content can be downloaded from a remote media server, or from a network-based content server (e.g., in the cloud) to the client device. The client device implements a proxy application between the media player and a media server from which the media content is received. In embodiments, a television set-top box, such as a digital video recorder (DVR), receives and records media content. The DVR content can then be re-purposed to support two modes of playback operation at a mobile client device. The DVR content can be communicated to the media server that then reformats the media content to a format for consumption by the mobile client device, and then the reformatted media content can be used in at least two modes: 1) downloaded where it is stored on the mobile client device for local playback at any time, and from anywhere, or 2) the mobile client device downloads the reformatted media content for simultaneous playback on the client device as an implementation of secure progressive download.

In an example system, the media server receives encrypted media content from a television client device, such as a DVR that records the media content. The media server receives and decrypts the encrypted media content via standard digital transmission content protection (DTCP). The media server then formats the decrypted media content for playback by the media player on the client device, such as from high-definition media content to VGA formatted media content, or to an MP2 format. The media server then re-encrypts the formatted media content for communication to the client device as encrypted, formatted media content.

In embodiments, the proxy application is implemented to receive the media content that is formatted and encrypted from the media server, and initiate storing the encrypted, formatted media content in data storage on the client device. The proxy application is also implemented to request the encryption key from the key server, receive the encryption key from the key server, and store the encryption key in the data storage on the client device. When the proxy application receives a request for the media content from the media player, the proxy application can retrieve the encryption key and the encrypted media content from the data storage. The proxy application then decrypts segments of the encrypted media content with the encryption key, and communicates the decrypted media content segments to the media player for playback on the client device.

In embodiments, the media content can be decrypted for playback by the application system, such as the proxy application, as segments of the media content are received for an implementation of secure progressive download. Alternatively, the media content can be decrypted and played back when the client device is no longer communicatively linked in a local network, such as when a user is traveling and wanting to display the media content (e.g., watch a recorded movie or television program).

While features and concepts of secure progressive download for media content playback can be implemented in any number of different devices, systems, networks, and/or configurations, embodiments of secure progressive download for media content playback are described in the context of the following example devices, systems, and methods.

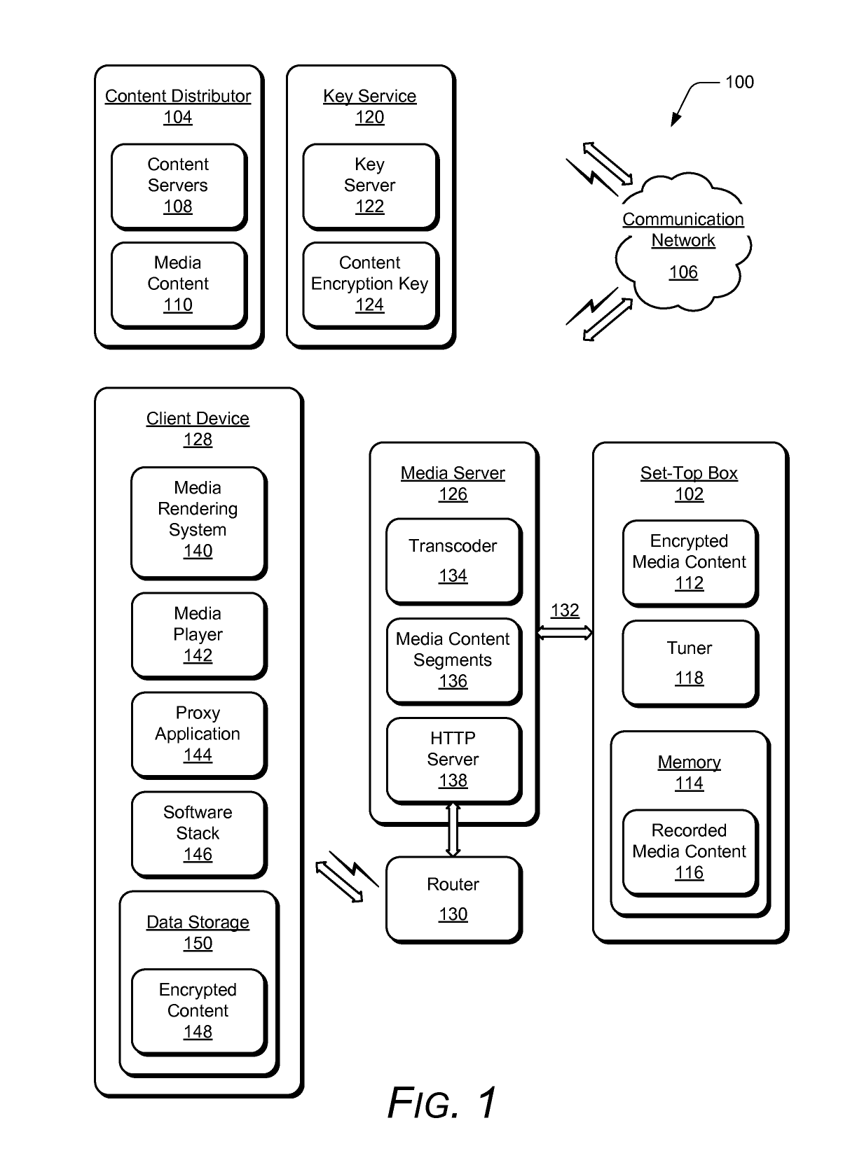

FIG. 1 illustrates an example system 100 in which embodiments of secure progressive download for media content playback can be implemented. The example system 100 includes a television set-top box 102, such as cable television box, digital video recorder (DVR), or any other type of television client device that receives media content from a headend via a service network. For example, a content distributor 104 and/or other media content sources deliver media content and data to any number of various devices via a communication network 106, such as to the television set-top box in a home or business environment.

The content distributor 104 includes content servers 108 to distribute media content 110 to the set-top box 102, such as live television and/or recorded on-demand video content that is distributed via a coaxial cable system or IP-based system. The set-top box 102 receives the media content from the content distributor as encrypted media content 112, which can include any type of audio, video, and/or image data in the form of television programming, movies, on-demand video, interactive games, advertisements, and the like. In a DVR implementation, the set-top box can record the encrypted media content with memory 114 that maintains the recorded media content 116. In this example, the set-top box 102 also includes a tuner 118 that tunes to a television channel frequency over which the media content is delivered. In addition, the set-top box can be implemented with various components, such as processor and memory devices, as well as with any combination of differing components as further described with reference to the example electronic device shown in FIG. 6.

The example system also includes a key service 120, such as any key encryption service and/or key service provider, that implements a key server 122 to distribute a content encryption key 124 (CEK) for secure delivery and communication of encrypted media content. In implementations, the encrypted media content is not dependent on a particular key server, and different key servers or services may be utilized for the secure delivery and communication of media content between devices, services, and/or components in the example system 100. The content distributor, key service, and/or the respective servers can be implemented with various components, such as processor and memory devices, as well as with any combination of differing components as further described with reference to the example electronic device shown in FIG. 6. For example, the content distributor and the key service include storage media, such as any type of memory and/or suitable electronic data storage, to store or otherwise maintain the media content and other data.

Any of the services, devices, and servers can communicate via the communication network 106, which can be implemented to include a wired and/or a wireless network. The communication network can also be implemented using any type of network topology and/or communication protocol, and can be represented or otherwise implemented as a combination of two or more networks, to include IP-based networks and/or the Internet. The communication network may also include mobile operator networks that are managed by a mobile network operator and/or other network operators, such as a communication service provider, cell-phone provider, and/or Internet service provider.

The example system 100 also includes a media server 126 that is implemented to communicate media content, such as recorded media content, to a client device 128 via a router 130 implemented for wired and/or wireless communication. The media server 126 receives the encrypted media content 112 and/or the recorded media content 116 from the set-top box 102 via an Ethernet connection 132. The media server is implemented to communicate and sync with the set-top box (and/or DVR) automatically, and provides a proprietary interface for media content look-up, transport, and protection. The media server decrypts the encrypted media content that is received from the set-top box via DTCP, and then transcodes the decrypted media content. The media server can also communicate with the key service 120 via the communication network 106 and receives a content encryption key 124 (CEK). The media server 126 can then utilize the content encryption key to re-encrypt the formatted (e.g., transcoded) media content.

The media server 126 includes a transcoder 134 to format the decrypted media content for distribution to the client device 128 as media content segments 136 with an HTTP server 138 via the router 130. For example, the media server formats high-definition media content received from the set-top box 102, such as MP4 media content, to VGA formatted media content, or to an MP2 format. The media content can be processed to determine a location of the metadata box and its file offset, and to locate and change the values for the encoded audio and the encoded video as part of the transcoding process. The media server 126 is implemented to then re-encrypt the formatted media content with the encryption key for communication to the client device via the router 130, so that the media content remains secure when communicated over WiFi™ or Ethernet to the client device.

The media server 126 can be implemented with various components, such as a processor and memory devices, as well as with any combination of differing components as further described with reference to the example electronic device shown in FIG. 6. For example, the media server 126 can include memory that is implemented to buffer the media content segments 136 that are transcoded and maintained for delivery to the client device 128. Further, although shown as an independent component or device, the media server 126 may be implemented as an integrated component or device of the set-top box 102. Alternatively, the media server 126 may be implemented as a network-based media server (e.g., in the cloud) to decrypt the encrypted media content, transcode the decrypted media content, and re-encrypt the formatted media content for distribution to the client device as encrypted, formatted media content.

In implementations, the media server 126 can serve as a portal server, the media content server, as well as a domain server. The client device 128 can discover a server name of the media server that can be used to resolve an IP address for the media server. The media server supports multicast domain name service (mDNS) for the name discovery and IP address resolution mechanism. The mDNS protocol allows the client device to discover the media server by obtaining its fully-qualified name and IP address. The client device can first multicast a query looking for the media server and then the media server's mDNS server responds by providing the fully qualified name (FQN) and IP address. The client device can then build its name resolution table and, when the media server FQN is used in an HTTP URI (uniform resource identifiers), the message will be sent to the media server correctly.

The client device 128 may be implemented as any one or combination of a communication, computer, media playback, gaming, entertainment, and/or electronic device, such as a mobile phone or tablet device that can be configured as a television client device to receive and playback media content. The client device can be implemented with various components, such as processor and memory devices, as well as with any combination of differing components as further described with reference to the example electronic device shown in FIG. 6. For example, the client device includes a media rendering system 140 to playback media content for viewing on an integrated display device.

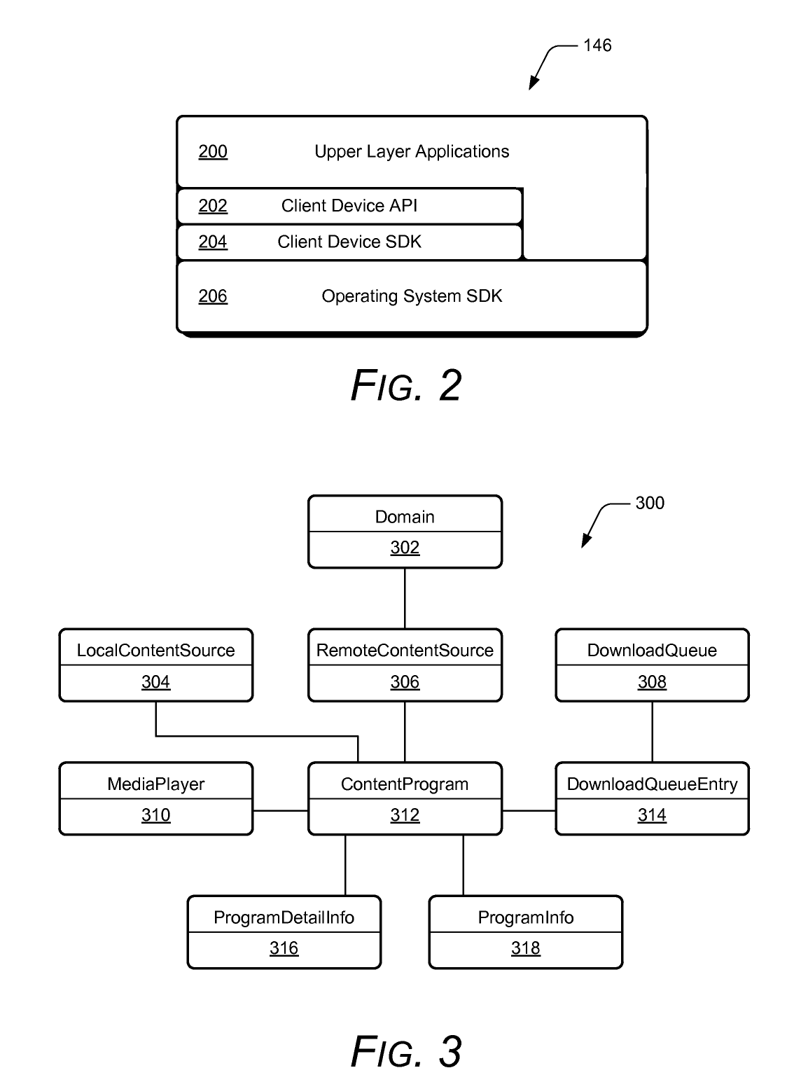

The client device can also include various client applications, such as a media player 142 that is implemented to manage the media content playback, as well as a proxy application 144 that can be implemented as computer-executable instructions, such as a software application, and executed by one or more processors to implement the various embodiments of secure progressive download for media content playback described herein. The client device can also include additional software and applications, such as the software stack 146 that is further described with reference to FIG. 2.

In embodiments, the proxy application 144 is implemented to receive the media content that is formatted and encrypted from the media server 126, such as being received wirelessly via the router 130. The proxy application can initiate storing the encrypted, formatted media content as the encrypted content 148 in data storage 150 on the client device 128. The proxy application is also implemented to request the content encryption key 124, receive the encryption key from the key server 122, and store the encryption key in the data storage 150 on the client device. In embodiments, the proxy application can receive encryption key request parameters from the media server 126, and utilize the encryption key request parameters to request the content encryption key 124 from the key service 120.

When the proxy application 144 receives a request for the media content from the media player, the proxy application can retrieve the encryption key and the encrypted media content from the data storage 150 on the client device. The proxy application 144 then decrypts segments of the encrypted media content with the encryption key, and communicates the decrypted media content segments to the media player 142 for playback on the client device. Accordingly, the media player operates as if performing a progressive download against clear content and is totally agnostic of the media content being received and/or stored as encrypted media content and then decrypted by the proxy application.

In embodiments, the media content can be decrypted by the proxy application for playback by the media player as segments of the media content are received for an implementation of secure progressive download. Alternatively or in addition, the media content can be downloaded and stored locally, and later decrypted and played back when the client device is no longer communicatively linked in the local network, such as when a user is traveling and wanting to display the media content (e.g., watch a recorded movie or television program). The client device can list and describe media server content; support progressive download of the media content; protect the media content transport and storage; enforce digital rights management (DRM) rules; support content playback with the media player; enforce domain control; and/or personalize and register user devices.

In embodiments, the proxy application 144 instantiates the media player 142 with an obfuscated URL pointing to itself, and the media player can determine the proxy application from the URL. The obfuscated URL can be generated randomly with a different value for each progressive download and/or local playback session, and the URL points back to the proxy application so that the media player knows where to request the media content from for playback. On the client device 128, the proxy application 144 executes first, and when a user of the client device initiates a request for media content playback, the proxy application generates the obfuscated URL and instantiates the media player 142. The media player can then communicate with the proxy application via an HTTP request and HTTP response. For example, when the media player requests media content from the proxy application, the proxy application, in turn, can request the media content from the media server or get the media content from locally stored content.

FIG. 2 illustrates an example of the software stack 146 referred to in FIG. 1, and implemented in the client device 128. In this example, the software stack includes upper layer applications 200 of the client device, a client device API set 202, a client device SDK 204 (software development kit), and an operating system SDK 206, such as for iOS or ANDROID operating systems. In embodiments, the client device SDK 204 is an implementation of a client object model architecture on the client device for object model domain-based content mobility.

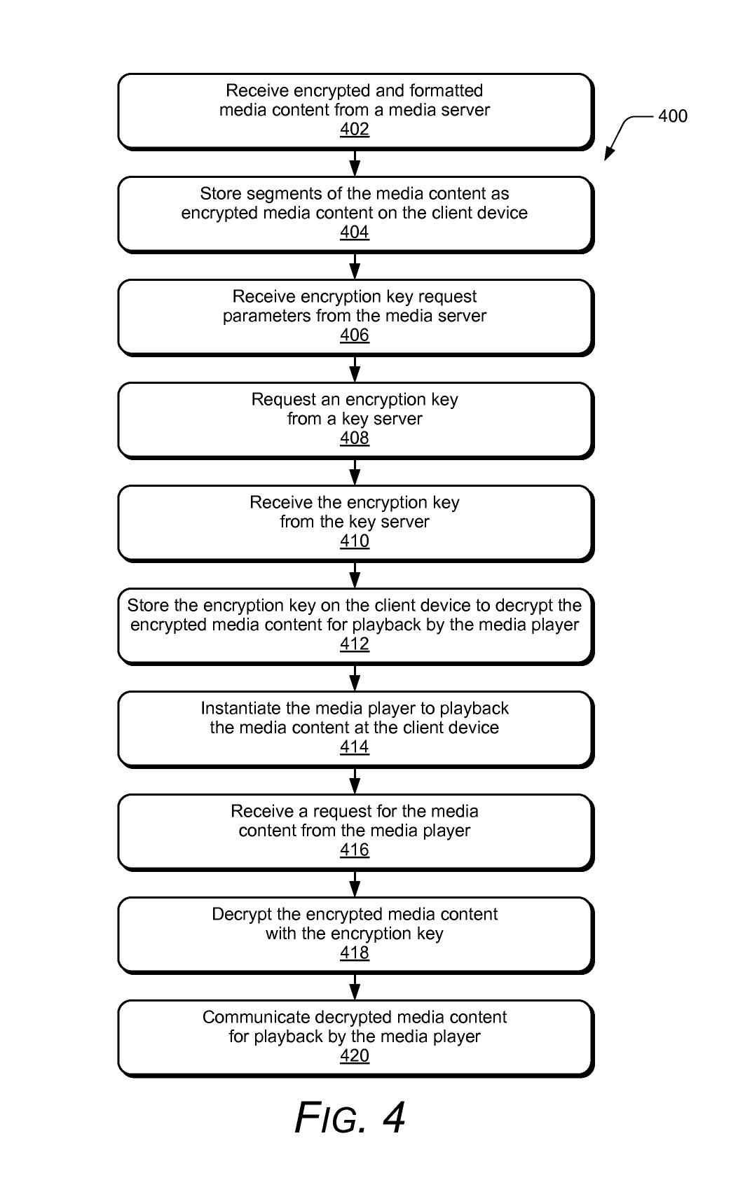

FIG. 3 illustrates an example client device API object model 300 that can be implemented on a client device, such as the client device 128 described with reference to FIG. 1. The client object model 300 includes a set of classes, the associated methods, and the relationships between the classes, as configured by the client device SDK 204 described with reference to FIG. 2. A domain controller can be instantiated from the domain class 302 for overall control of the object model and to control the domain discovery of the media server 126, the domain-based registration of the client device with the media server, and authentication of the client device 128 to the media server 126 so that the client device is trusted to receive the encrypted, formatted media content from the media server.

In addition to the domain class 302, the object model 300 includes a local content source class 304; a remote content source class 306; a download queue class 308; a media player class 310 (e.g., such as to instantiate the media player 142 in the client device 128); a content program class 312; a download queue entry class 314; a program detail info class 316; and a program info class 318. The local content source class 304 includes functionality to control the media content that is already securely downloaded and maintained on the client device 128. The local content source class also controls displaying metadata that corresponds to the media content and deletion of the metadata.

The remote content source class 306 represents the media server 126 and includes functionality to interface with the media server. The remote content source class also provides methods to retrieve a remote content list and download remote media content, such as remote media content that can be streamed to the client device. In an implementation, remote media content usage control can be enforced by the Internet Protocol Rights Management (IPRM) system according to its copyrights. A remote content list includes the state of all the different remote media content and is sorted by the content state. An update to the remote content list is notified via a multicast domain name service (mDNS) message, and can provide attributes of the media content, such as the ID, descriptions, parental control information, playback duration, ratings, the content file URLs, the icon URLs, protection type, series name, and the episode name.

The download queue entry class 314 includes functionality to manage the media content that is scheduled to download to the client device, and the download queue class 308 provides methods to manage download queue entry. Before media content is fully downloaded from the media server to the client device, the media content is an entry in a download queue. The download queue class 308 can manage a deletion from the download queue, a stop and restart of a download, a change of the media content download order, a report of media content download progress. Further, downloaded media content is protected by the IPRM system, can be stored persistently on the client device, and the media content is playback ready (e.g., the audio/video data of the media content can be rendered with or without connection to the remote content source). The metadata that corresponds to the media content can also be stored persistently on the client device.

The media player class 310 represents the media player 142 that is instantiated by the proxy application 144, and includes functionality to control playback of recorded media content and/or streaming media content on the client device. The playback of the recorded media content, and playback of the streaming media content, are both different instantiations of the media player class. The content program class 312 represents one of local recorded media content (e.g., the local content source class 304) or remote streaming media content (e.g., the remote content source 306). The program detail information class 316 includes metadata corresponding to the media content, and the program information class 318 includes information about an individual program.

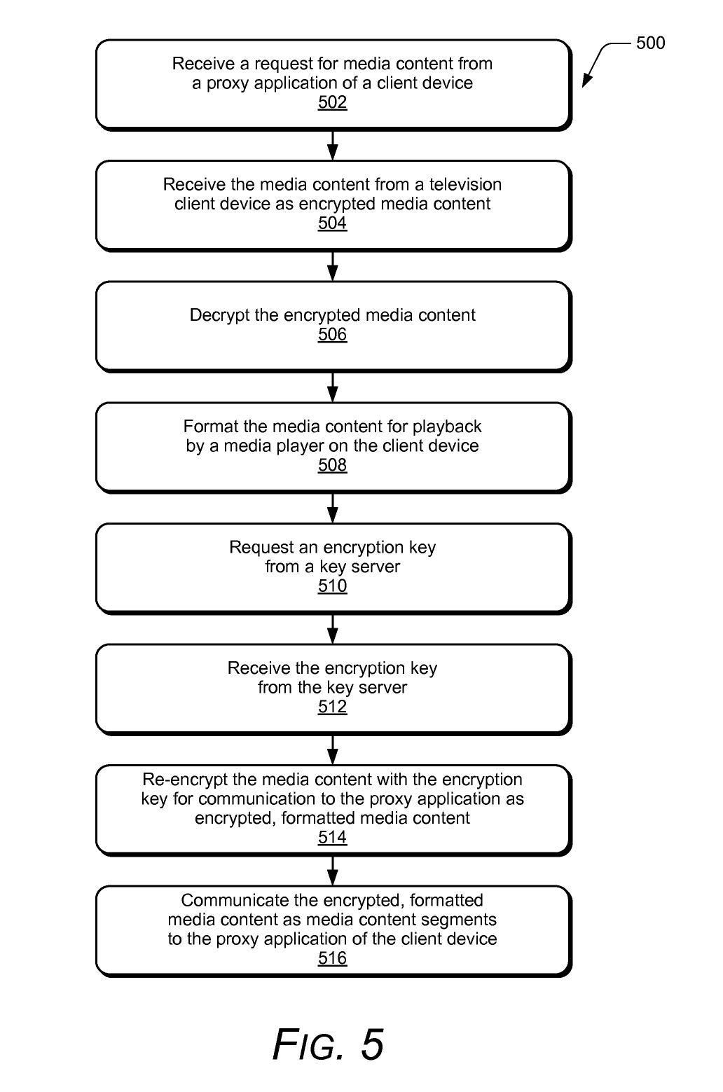

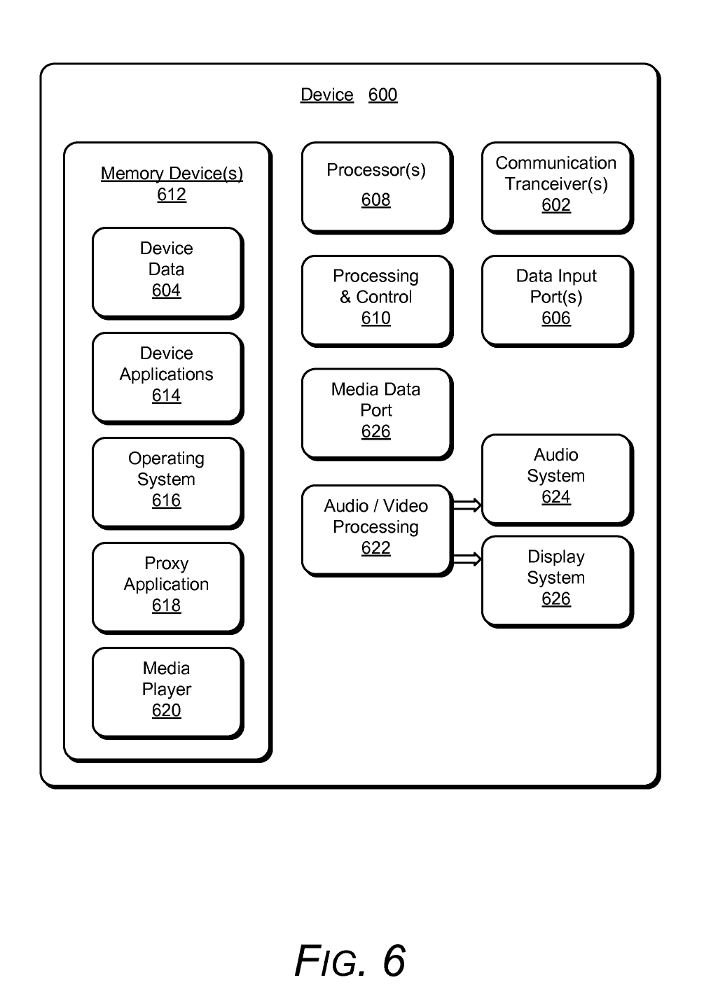

Example methods 400 and 500 are described with reference to respective FIGS. 4 and 5 in accordance with one or more embodiments of secure progressive download for media content playback. Generally, any of the services, functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable storage media devices, both local and/or remote to a computer processor. The methods may also be practiced in a distributed computing environment by multiple computer devices. Further, the features described herein are platform-independent and can be implemented on a variety of computing platforms having a variety of processors.

FIG. 4 illustrates example method(s) 400 of secure progressive download for media content playback, and is described with reference to embodiments of a proxy application. The order in which the method blocks are described are not intended to be construed as a limitation, and any number or combination of the described method blocks can be combined in any order to implement a method, or an alternate method.

At block 402, encrypted and formatted media content is received from a media server. For example, the proxy application 144 at the client device 128 (FIG. 1) receives encrypted, formatted media content from the media server 126 for playback by the media player 142 on the client device. The client device, such as a mobile phone, can receive the encrypted, formatted media content from the media server via wireless communication, and the mobile phone includes the media player to playback the media content for display on the mobile phone. Alternatively, the client device, such as a computer device, can receive the encrypted, formatted media content from the media server via Ethernet.

At block 404, segments of the media content are stored as encrypted media content on the client device. For example, the proxy application 144 initiates storing segments of the media content as the encrypted content 148 in the data storage 150 on the client device 128. At block 406, encryption key request parameters are received from the media server. For example, the proxy application 144 receives encryption key request parameters from the media server 126, such as in a media content playlist or other data file.

At block 408, an encryption key is requested from a key server and, at block 410, the encryption key is received from the key server. For example, the proxy application 144 at the client device 128 requests the encryption key 124 from the key server 122 utilizing the encryption key request parameters, and receives the encryption key back from the key server. At block 412, the encryption key is stored on the client device to decrypt the encrypted media content for playback by the media player. For example, the proxy application 144 initiates storing the encryption key 124 in the data storage 150 on the client device.

At block 414, the media player is instantiated to playback the media content at the client device. For example, the proxy application 144 at the client device 128 instantiates the media player 142 to playback the media content on the client device, such as to display video and render corresponding audio. At block 416, a request for the media content is received from the media player. For example, the proxy application 144 at the client device 128 receives a request for media content from the media player 142.

At block 418, the encrypted media content is decrypted with the encryption key. For example, the proxy application 144 decrypts the encrypted content 148 with the encryption key 124 that is stored in the data storage 150 on the client device 128. The media content can be decrypted for playback by the media player 142 as segments of the media content are received for an implementation of secure progressive download, or the media content can be decrypted when the client device is no longer communicatively linked in a local network, such as when a user is traveling and wanting to display the media content (e.g., watch a recorded movie or television program).

At block 420, decrypted media content is communicated for playback by the media player. For example, the proxy application 144 communicates the decrypted media content for playback by the media player 142, such as to display the media content on the client device.

FIG. 5 illustrates example method(s) 500 of secure progressive download for media content playback, and is described with reference to embodiments of a media server. The order in which the method blocks are described are not intended to be construed as a limitation, and any number or combination of the described method blocks can be combined in any order to implement a method, or an alternate method.

At block 502, a request for media content is received from a proxy application of a client device. For example, the media server 126 (FIG. 1) receives a request for media content from the proxy application 144 of the client device 128. At block 504, the media content is received from a television client device as encrypted media content. For example, the media server 126 receives the media content from the set-top box 102 (e.g., a DVR or any other type of television client device) as the encrypted media content 112 and/or the recorded media content 116.

At block 506, the encrypted media content is decrypted. For example, the media server 126 decrypts the encrypted media content via a DTCP security mechanism. At block 508, the media content is formatted for playback by a media player on the client device. For example, the transcoder 134 of the media server 126 formats the media content for playback by the media player 142 on the client device 128. In an implementation, the media server transcodes high definition media content to a VGA format for playback by the media player on the client device.

At block 510, an encryption key is requested from a key server and, at block 512, the encryption key is received from the key server. For example, the media server 126 requests the encryption key 124 from the key server 122 at the key service 120, and the media server receives the encryption key from the key server. At block 514, the media content is re-encrypted with the encryption key for communication to the proxy application as encrypted, formatted media content. For example, the media server 126 re-encrypts the media content with the encryption key 124 for communication of the encrypted, formatted media content to the proxy application 144 at the client device 128.

At block 516, the encrypted, formatted media content is communicated as media content segments to the proxy application of the client device. For example, the media server 126 communicates the encrypted, formatted media content as media content segments 136 to the proxy application 144 of the client device 128. In an embodiment, the media content segments are communicated to the client device as a progressive download of the media content for decryption by the proxy application 144 and playback by the media player 142 on the client device. Further, the encrypted, formatted media content can be communicated to the client device via wireless communication, such as via wireless communication to a mobile phone.

FIG. 6 illustrates various components of an example electronic device 600 that can be implemented as any device described with reference to any of the previous FIGS. 1-5. In embodiments, the electronic device may be implemented as a media server or a client device, such as described with reference to FIG. 1. Alternatively or in addition, the electronic device may be implemented in any form of device that can receive and playback live or recorded video content, such as any one or combination of a communication, computer, media playback, gaming, entertainment, mobile phone, and/or tablet computing device.

The electronic device 600 includes communication transceivers 602 that enable wired and/or wireless communication of device data 604, such as received data, data that is being received, data scheduled for broadcast, data packets of the data, etc. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular telephony, wireless metropolitan area network (WMAN) radios compliant with various IEEE 802.15 (WiMAX™) standards, and wired local area network (LAN) Ethernet transceivers.

The electronic device 600 may also include one or more data input ports 606 via which any type of data, media content, and/or inputs can be received, such as user-selectable inputs, messages, music, television content, recorded video content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the electronic device to components, peripherals, or accessories such as microphones and/or cameras.

The electronic device 600 includes one or more processors 608 (e.g., any of microprocessors, controllers, and the like), which process computer-executable instructions to control operation of the device. Alternatively or in addition, the electronic device can be implemented with any one or combination of software, hardware, firmware, or fixed logic circuitry that is implemented in connection with processing and control circuits, which are generally identified at 610. Although not shown, the electronic device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The electronic device 600 also includes one or more memory devices 612 that enable data storage, examples of which include random access memory (RAM), non-volatile memory (e.g., read-only memory (ROM), flash memory, EPROM, EEPROM, etc.), and a disk storage device. A disk storage device may be implemented as any type of magnetic or optical storage device, such as a hard disk drive, a recordable and/or rewriteable disc, any type of a digital versatile disc (DVD), and the like. The electronic device 600 may also include a mass storage media device.

A memory device 612 provides data storage mechanisms to store the device data 604, other types of information and/or data, and various device applications 614 (e.g., software applications). For example, an operating system 616 can be maintained as software instructions within a memory device and executed on the processors 608. The device applications may also include a device manager, such as any form of a control application, software application, signal-processing and control module, code that is native to a particular device, a hardware abstraction layer for a particular device, and so on. The electronic device may also include a proxy application 618 and a media player 620, such as for a client device, to implement embodiments of secure progressive download for media content playback.

The electronic device 600 also includes an audio and/or video processing system 622 that generates audio data for an audio system 624 and/or generates display data for a display system 626. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 626. In implementations, the audio system and/or the display system are external components to the electronic device. Alternatively, the audio system and/or the display system are integrated components of the example electronic device.

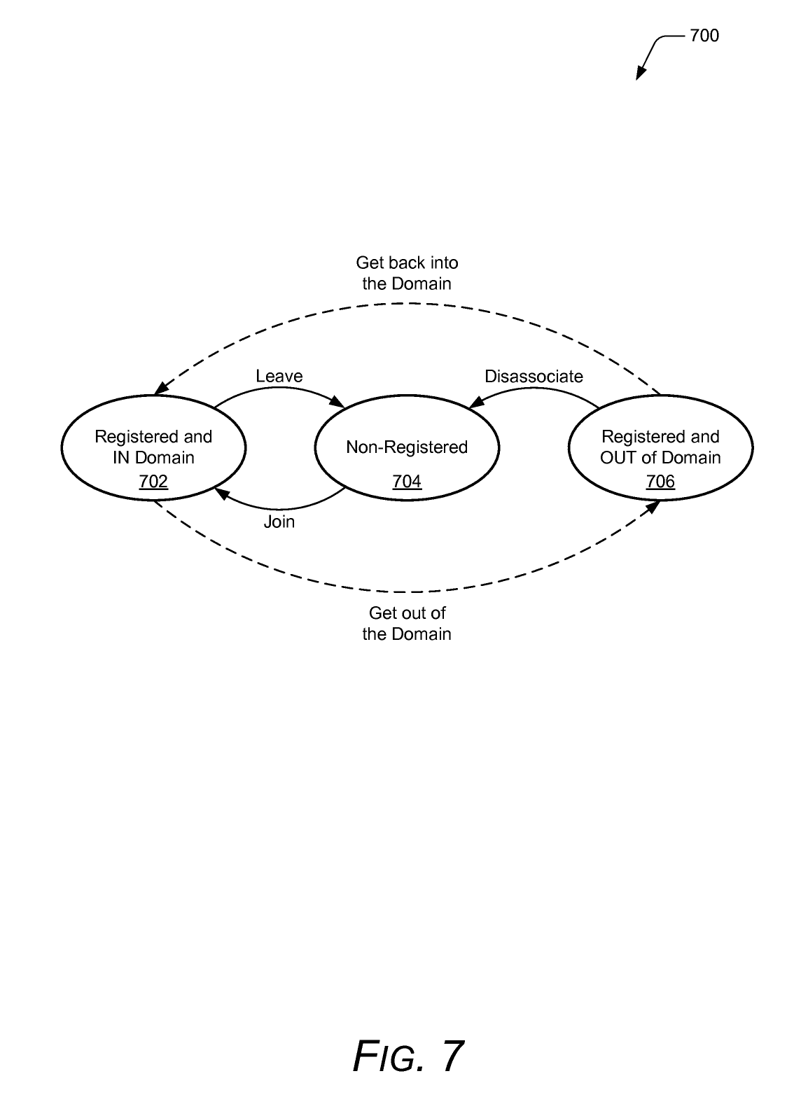

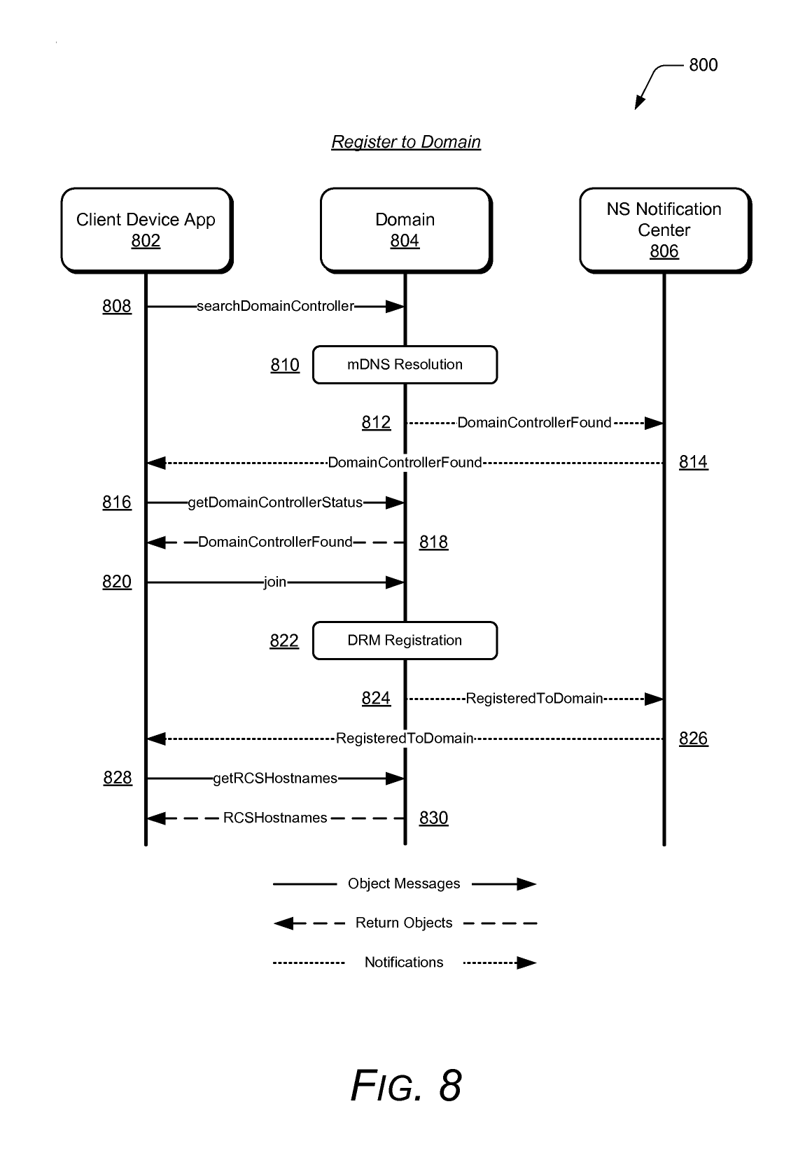

FIG. 7 illustrates an example state diagram 700 of client device registration state transitions, and registration to the domain object. Client device registration is controlled by a domain controller that is instantiated from the domain class 302 of the client object model. The example state diagram 700 includes a ‘registered and in domain’ state 702 that indicates the client device is registered to the domain; a ‘non-registered’ state 704 that indicates the client device is not registered to the domain; and a ‘registered and out of domain’ state 706 that indicates the client device is registered in the domain, but is out of communication range. For example, the client device may be out of range to communicate in the domain via router 130 of the system described with reference to FIG. 1. The example state diagram 700 also illustrates programmable transitions to leave, join, and disassociate, as well as non-programmable transitions to get back into the domain, or get out of the domain.

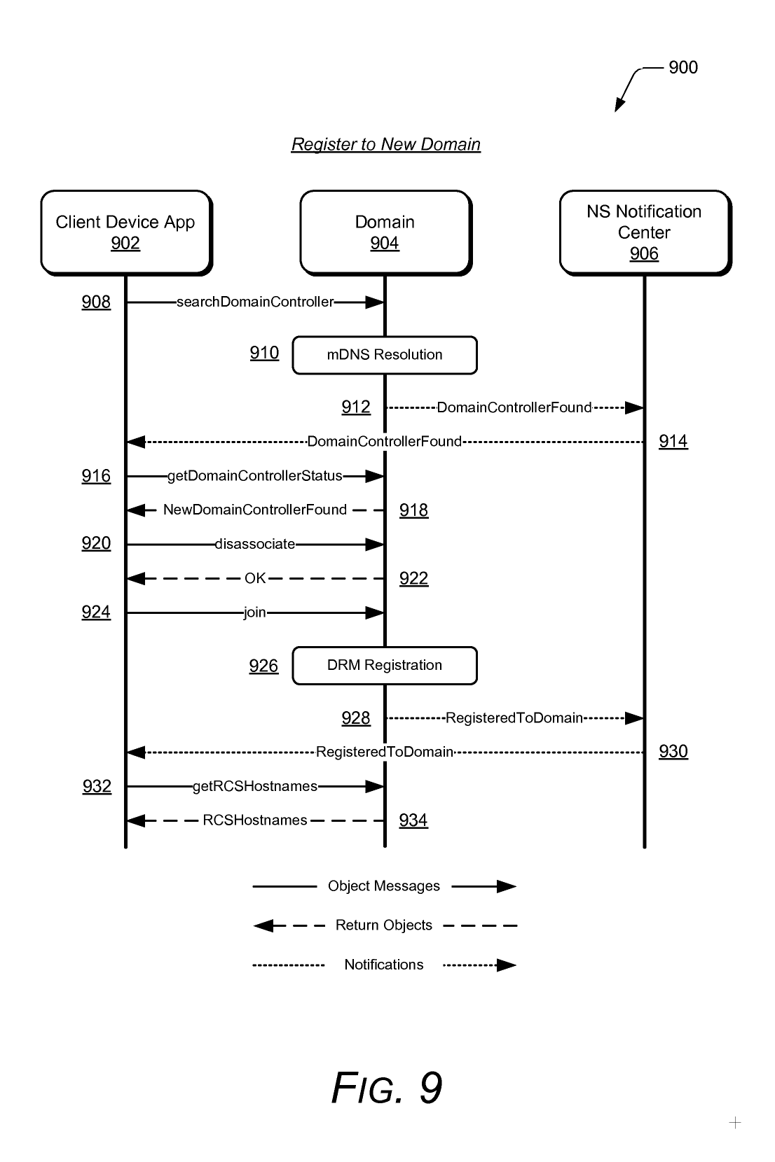

FIGS. 8-18 illustrate respective API object model communication sequence diagrams between the components, devices, and entities in a client object model domain in accordance with one or more embodiments of a client object model architecture. The client object model 300 described with reference to FIG. 3 includes the set of classes, the associated methods, and shows the relationships between the classes. The client object model includes the set of APIs to implement the object model, and the object model communication sequence diagrams shown in FIGS. 8-18 illustrate the object model APIs. Further, a Representational State Transfer (REST) software architecture is described below as the REST API specification that includes the API definitions of the object model classes that are described with reference to the client object model 300 shown in FIG. 3.

FIG. 8 illustrates an example of a Register to Domain communication sequence 800 between a client device application 802 (also referred to herein as a mover client application, such as implemented on the client device 128), a domain 804, and a NS (name service) notification center 806 to register a client device to the client object model domain. The domain 804 is an example of the domain class 302 described with reference to FIG. 3, from which a domain controller can be instantiated for overall control of the object model. In the example communication sequence 800, the client device application 802 initiates a search domain controller object message 808, and the domain 804 utilizes Multicast DNS (mDNS) resolution 810 that allows the client device application to discover the domain, as described above with reference to the media server 126 shown in FIG. 1, and as described below with reference to Mover Discovery and Name Resolution in the REST API specification.

The domain 804 communicates a domain controller found notification 812 to NS notification center 806, which communicates a domain controller found notification 814 back to the client device application 802. The client device application communicates a get domain controller status message 816, and the domain returns a domain controller found object 818. The client device application then communicates a join object message 820 to the domain, which utilizes DRM registration 822 to register the client device to the domain, and communicates a registered to domain notification 824 to the NS notification center. The NS notification center returns a registered to domain notification 826 to the client device application. The client device application then communicates a get RCS hostnames object message 828 to the domain, which returns the RCS hostnames object 830 to the client device application.

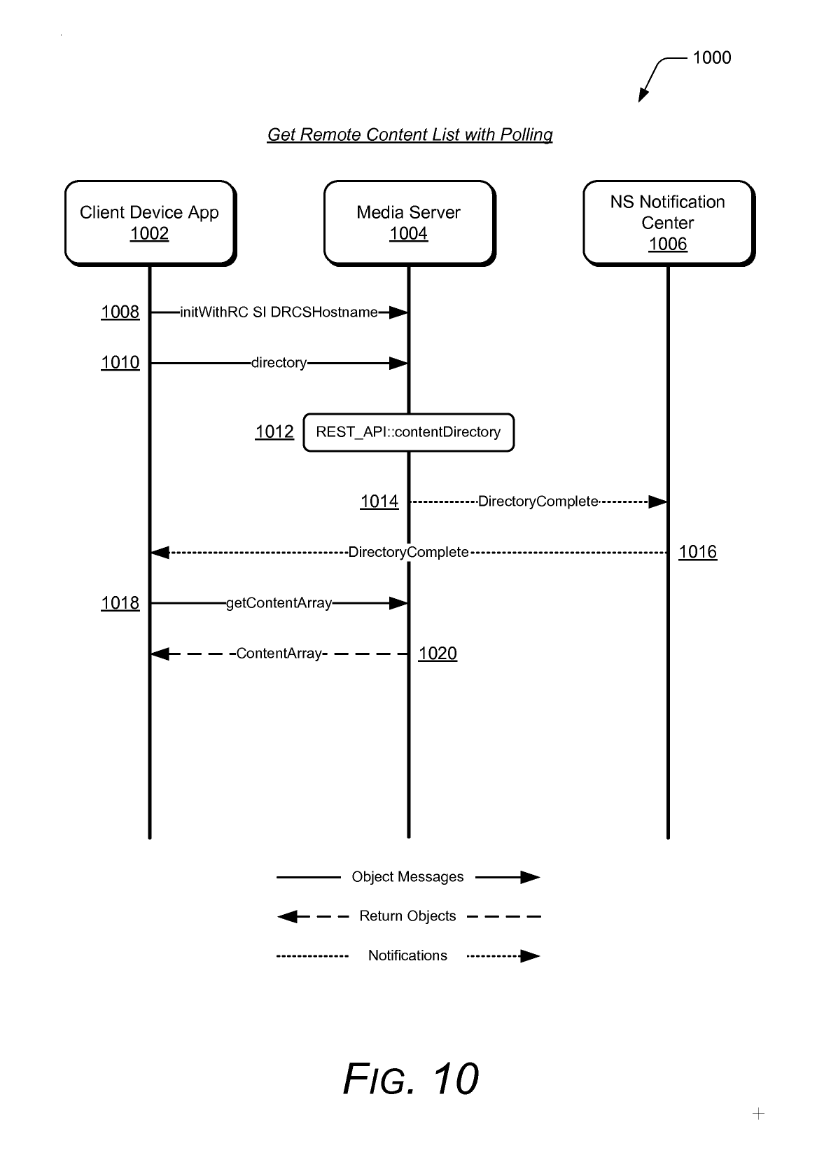

FIG. 9 illustrates an example of a Register to a New Domain communication sequence 900 between a client device application 902, a domain 904, and an NS notification center 906 to register a client device to a new domain, such as the client object model domain 302 described with reference to FIG. 3. The client device application 902 can be implemented on the client device 128 as described with reference to FIG. 1. In the example communication sequence 900, the client device application 902 initiates a search domain controller object message 908, and the domain 904 utilizes Multicast DNS (mDNS) resolution 910 that allows the client device application to discover the domain, as described above with reference to the media server 126 shown in FIG. 1, and as described below with reference to Mover Discovery and Name Resolution in the REST API specification.

The domain 904 communicates a domain controller found notification 912 to the NS notification center 906, which communicates a domain controller found notification 914 back to the client device application 902. The client device application communicates a get domain controller status message 916, and the domain returns a new domain controller found object 918. The client device application can communicate a disassociate object message 920 to the domain, and receive an ok return object 922 from the domain. The client device application then communicates a join object message 924 to the domain, which utilizes DRM registration 926 to register the client device to the new domain, and communicates a registered to domain notification 928 to the NS notification center. The NS notification center returns a registered to domain notification 930 to the client device application. The client device application then communicates a get RCS hostnames object message 932 to the domain, which returns the RCS hostnames object 934 to the client device application.

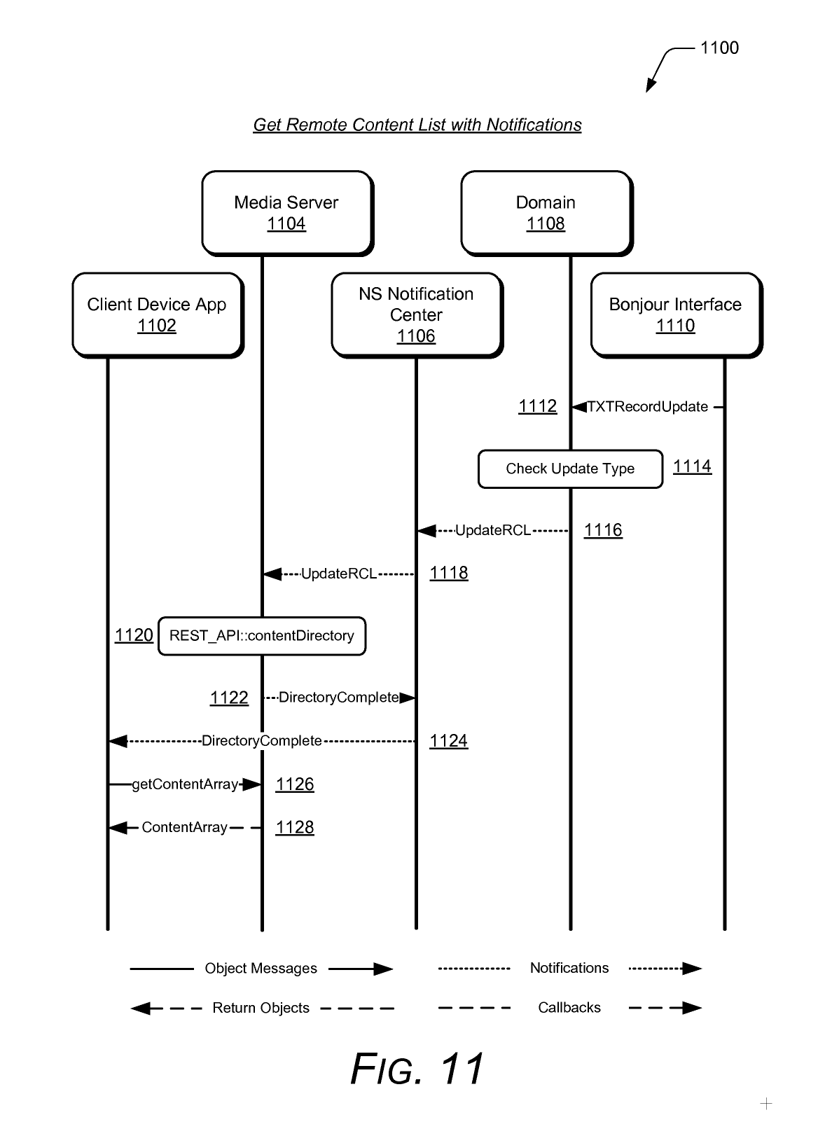

FIG. 10 illustrates an example of a Get Remote Content List with Polling communication sequence 1000 between a client device application 1002, a media server 1004 (also referred to herein as a remote content source), and an NS notification center 1006 to obtain a remote content list from the media server. The media server 1004 is an example of the media server 126, and the client device application 1002 can be implemented on the client device 128 as described with reference to FIG. 1. In the example communication sequence 1000, the client device application 1002 initiates an object message 1008 (initWithRC SI DRCS Hostname), and initiates a directory object message 1010. The media server 1004 references the REST API content directory URI 1012 that provides the list of programs currently in the media server database, such as described below with reference to the content directory URI in the REST API specification. The media server communicates a directory complete notification 1014 to the NS notification center 1006, which returns a directory complete notification 1016 to the client device application. The client device application then communicates a get content array object message 1018 to the media server, which replies with a content array return object 1020.

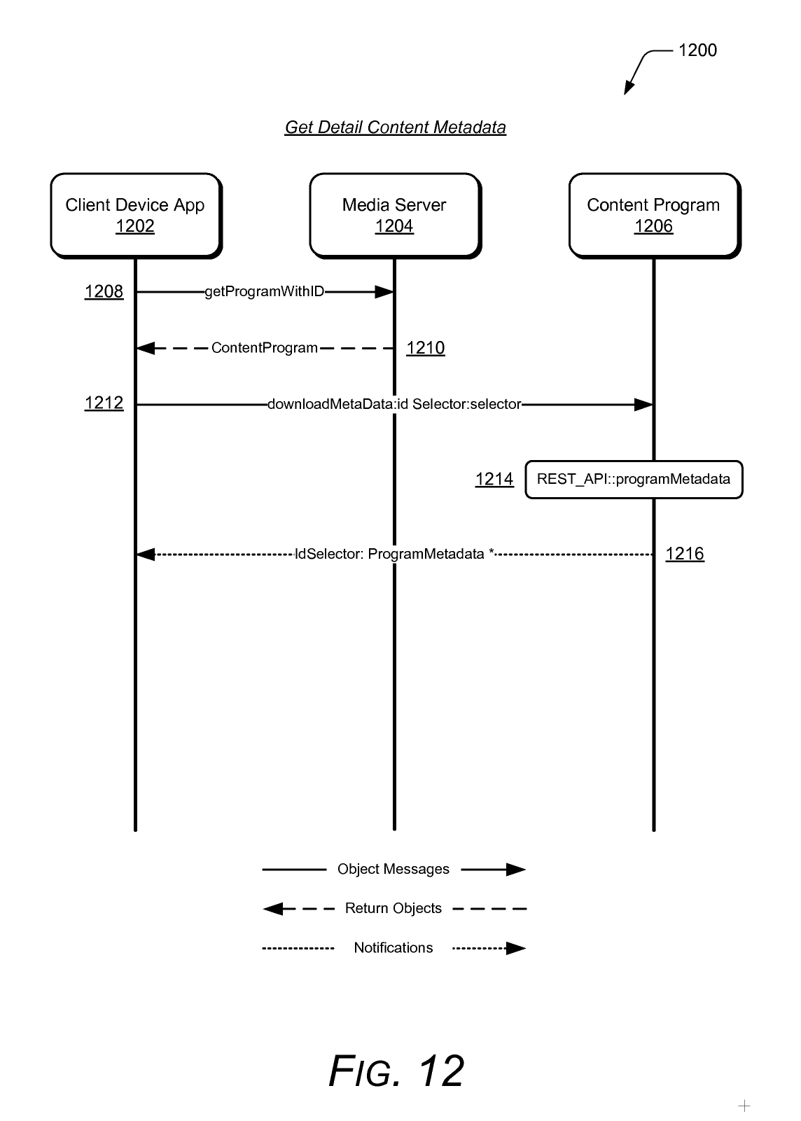

FIG. 11 illustrates an example of a Get Remote Content List with Notifications communication sequence 1100 between a client device application 1102, a media server 1104, an NS notification center 1106, a domain 1108, and an interface 1110 to obtain a remote content list with notifications. The media server 1104 is an example of the media server 126, and the client device application 1102 can be implemented on the client device 128 as described with reference to FIG. 1. Further, the domain 1108 is an example of the domain class 302 described with reference to FIG. 3, from which a domain controller can be instantiated for overall control of the object model. In the example communication sequence 1100, the interface 1110 communicates a TXT record update object message 1112 to the domain 1108, which initiates a check update type 1114 of remote media content. The domain communicates an update RCL notification 1116 to the NS notification center 1106, which communicates the update RCL notification (at 1118) to the media server 1104. The media server references the REST API content directory URI 1120 that provides the list of programs, such as described below with reference to the content directory URI in the REST API specification.

The media server 1104 communicates a directory complete notification 1122 to the NS notification center 1106, which returns a directory complete notification 1124 to the client device application 1102. The client device application then communicates a get content array object message 1126 to the media server, which returns a content array object 1128.

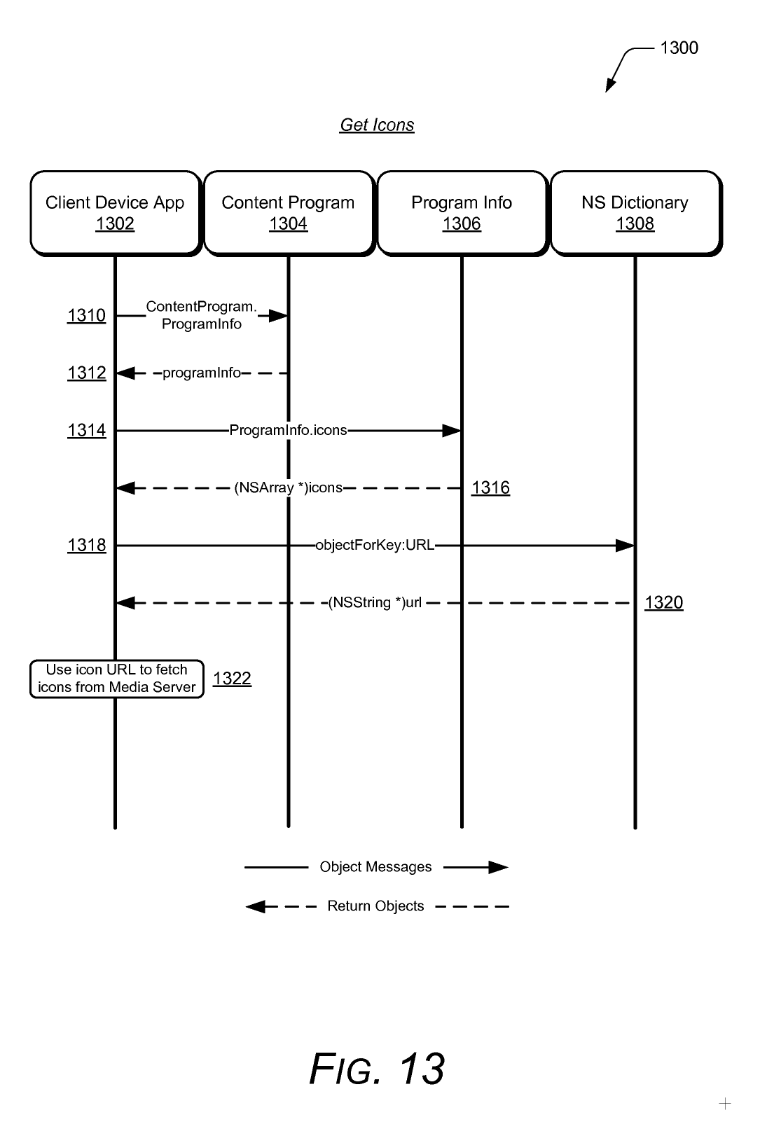

FIG. 12 illustrates an example of a Get Detail Content Metadata communication sequence 1200 between a client device application 1202, a media server 1204, and a content program object 1206 to obtain media content metadata from the media server. The media server 1204 is an example of the media server 126, and the client device application 1202 can be implemented on the client device 128 as described with reference to FIG. 1. Further, the content program object 1206 is an example of the content program class 312 in the client device API object model 300 described with reference to FIG. 3, and the content program class 312 represents one of local recorded media content (e.g., the local content source class 304) or remote streaming media content (e.g., the remote content source 306).

In the example communication sequence 1200, the client device application 1202 initiates a get program with ID object message 1208 to the media server 1204, which returns a content program object 1210. The client device application then communicates a download metadata object message 1212 (download metadata:id selector:selector) to obtain the content program 1206. The media server 1204 references the REST API program metadata URI 1214, which can be used to download the detailed program representation of any program using the program-id as described below with reference to the program metadata URI in the REST API specification. A program metadata notification 1216 (Id selector: program metadata) is then communicated back to the client device application.

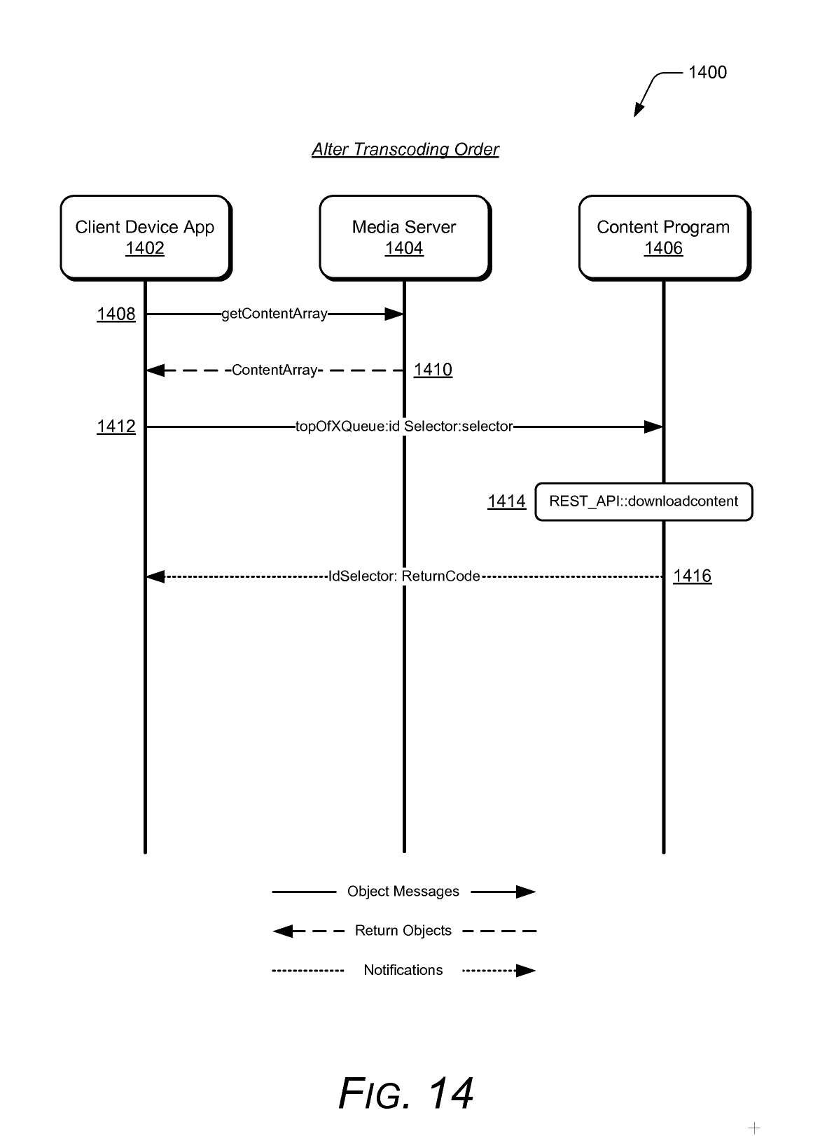

FIG. 13 illustrates an example of a Get Icons communication sequence 1300 between a client device application 1302, a content program object 1304, program info object 1306, and an NS dictionary 1308 to get icons. The client device application 1302 can be implemented on the client device 128 as described with reference to FIG. 1. Further, the content program object 1304 is an example of the content program class 312 in the client device API object model 300 described with reference to FIG. 3, and the content program class 312 represents one of local recorded media content (e.g., the local content source class 304) or remote streaming media content (e.g., the remote content source 306). The program info object 1306 is an example of the program info class 318 in the client device API object model 300, and the program info class 318 includes information about individual programs (e.g., media content, streaming media content, recorded media content, and the like).

In the example communication sequence 1300, the client device application 1302 initiates an object message request 1310 for program information, and the content program object 1304 returns the program information 1312 to the client device application. The client device application then communicates a program info.icons object message 1314 to the program info object 1306, which returns an icons array 1316 (NS array icons) to the client device application. The client device application then communicates a object for key: URL message 1318 to the NS dictionary 1308, which returns a URL string 1320 (NS string URL) to the client device application. The client device application can then use the icon URL to fetch icons from the media server at 1322 (e.g., the media server 126 as described with reference to FIG. 1).

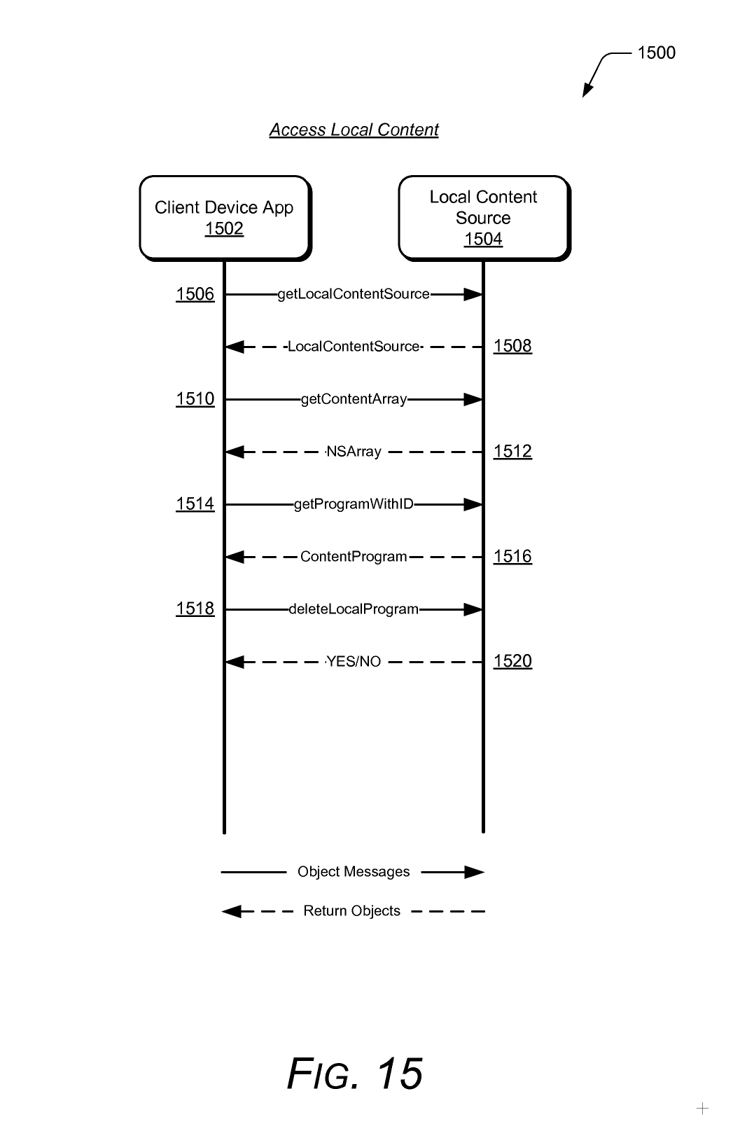

FIG. 14 illustrates an example of an Alter Transcoding Order communication sequence 1400 between a client device application 1402, a media server 1404, and a content program object 1406 to alter an order of media content transcoding at the media server. The media server 1404 is an example of the media server 126, and the client device application 1402 can be implemented on the client device 128 as described with reference to FIG. 1. Further, the content program object 1406 is an example of the content program class 312 in the client device API object model 300 described with reference to FIG. 3, and the content program class 312 represents one of local recorded media content (e.g., the local content source class 304) or remote streaming media content (e.g., the remote content source 306).

In the example communication sequence 1400, the client device application 1402 initiates a get content array object message 1408 to the media server 1404, which returns the content array object 1410 to the client device application. The client device application then communicates a top of queue object message 1412 (top of X queue: id selector:selector) to the content program object 1406. The content program object references the REST API download content URI 1414 and then returns an Id selector: return code notification 1416 to the client device application.

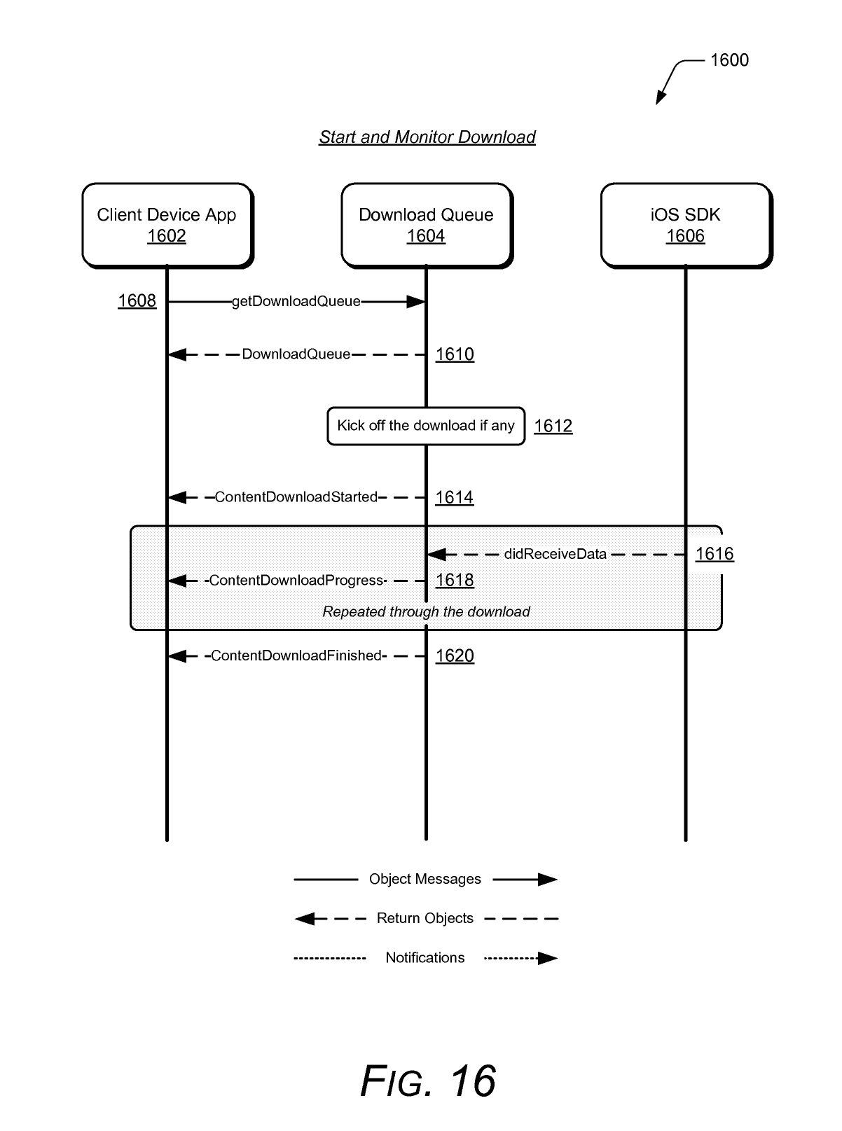

FIG. 15 illustrates an example of an Access Local Content communication sequence 1500 between a client device application 1502 and a local content source object 1504 (e.g., data storage on the client device). The client device application 1502 can be implemented on the client device 128 as described with reference to FIG. 1. Further, the local content source object 1504 is an example of the local content source class 304 in the client device API object model 300 described with reference to FIG. 3. The local content source class 304 includes functionality to control the media content that is already securely downloaded and maintained on the client device 128.

In the example communication sequence 1500, the client device application 1502 initiates a request for local media content as a get local content source object message 1506, and the local content source object 1504 returns a local content source object 1508 to the client device application. The client device application then communicates a get content array object message 1510 to the local content source object, which returns an NS array object 1512 to the client device application. The client device application then communicates a get program with ID object message 1514 to the local content source object, which returns a content program object 1516 to the client device application. The client device application then communicates a delete local program object message 1518 to the local content source object, which returns a yes or no object 1520 to the client device application.

FIG. 16 illustrates an example of a Start and Monitor Download communication sequence 1600 between a client device application 1602, a download queue object 1604, and an iOS SDK 1606 to start and monitor a media content download to the client device. The client device application 1602 can be implemented on the client device 128 as described with reference to FIG. 1. Further, the download queue object 1604 is an example of the download queue class 308 in the client device API object model 300 described with reference to FIG. 3. The download queue class 308 provides methods to manage download queue entry for media content that is queued to download to the client device. The iOS SDK 1606 is an example of the operating system SDK 206 in the software stack 146 that is shown in FIG. 2, and can be implemented in the client device 128.

In the example communication sequence 1600, the client device application 1602 initiates a get download queue object message 1608 to the download queue object 1604, which returns the download queue return object 1610 to the client device application. The download queue object 1604 then begins a download 1612 of media content to the client device (if applicable), and can communicate a content download started object 1614 to the client device application. The iOS SDK 1606 communicates a did receive data return object 1616 to the download queue object 1604, which then communicates a content download progress object 1618 to the client device application. The did receive data return object 1616 from the iOS SDK and the content download progress object 1618 from the download queue object 1604 to the client device application is repeated through the download of the media content to the client device. The download queue object 1604 can then communicate a content download finished object 1620 to the client device application.

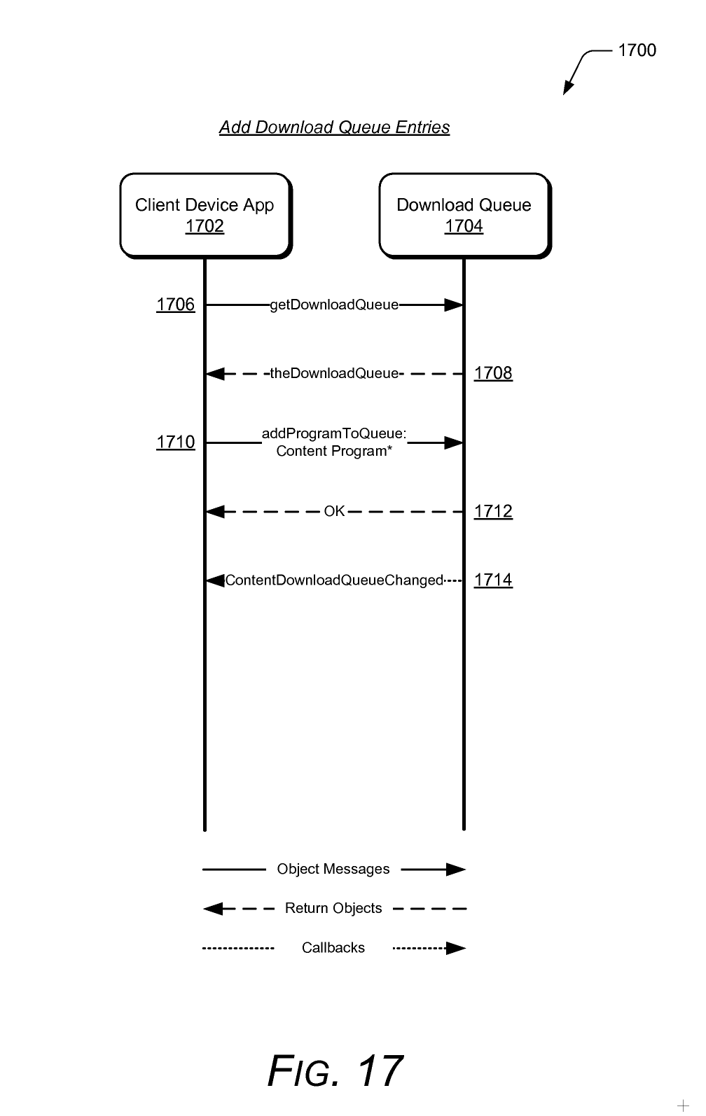

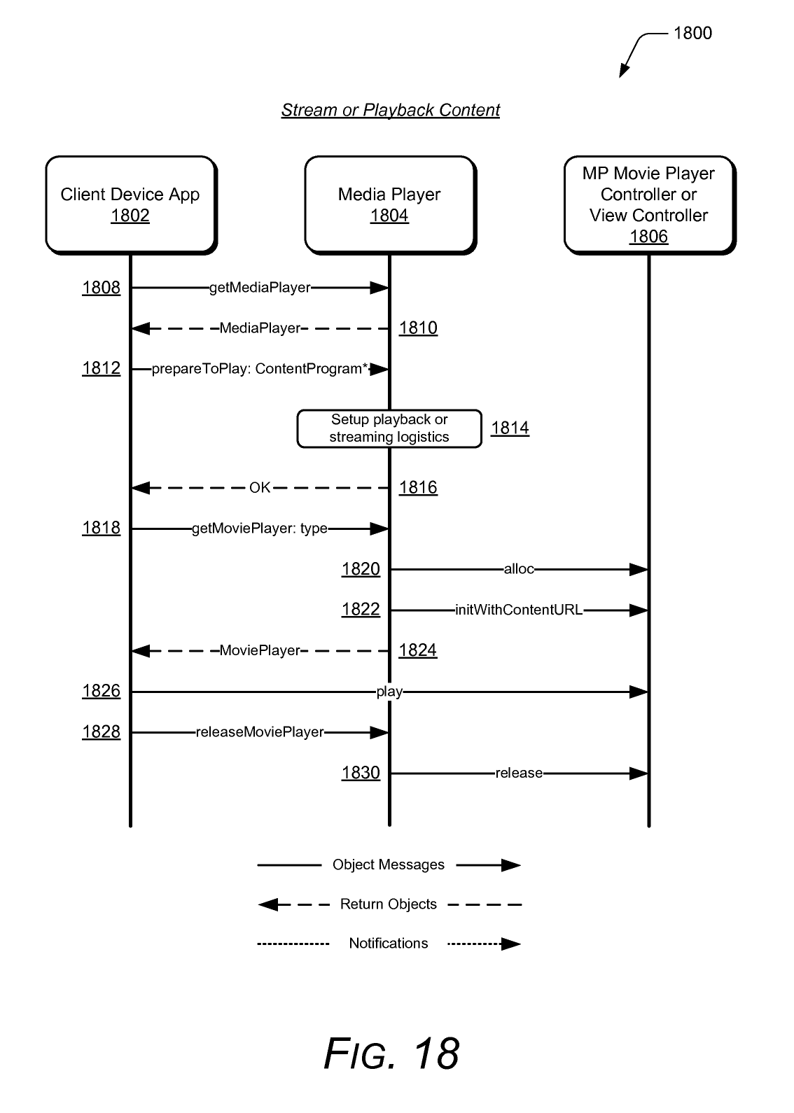

FIG. 17 illustrates an example of an Add Download Queue Entries communication sequence 1700 between a client device application 1702 and a download queue object 1704 to add additional media content to the sequence of media content in the download queue for download to the client device. The client device application 1702 can be implemented on the client device 128 as described with reference to FIG. 1. Further, the download queue object 1704 is an example of the download queue class 308 in the client device API object model 300 described with reference to FIG. 3. The download queue class 308 provides methods to manage download queue entry for media content that is queued to download to the client device.

In the example communication sequence 1700, the client device application 1702 initiates a get download queue object message 1706 to the download queue object 1704, which returns the download queue return object 1708 to the client device application. The client device application then communicates an add program to queue object message 1710 (add program to queue: content program) to the download queue object 1704, which returns an ok object response 1712 to the client device application. The download queue object also communicates a content download queue changed return object 1714 to the client device application.

FIG. 18 illustrates an example of a Stream or Playback Content communication sequence 1800 between a client device application 1802, a media player object 1804, and an MP (MPEG) movie player controller or view controller 1806 (MP controller) to stream media content or playback media content on the client device. The client device application 1802 can be implemented on the client device 128 as described with reference to FIG. 1. Further, the media player object 1804 is an example of the media player class 310 in the client device API object model 300 described with reference to FIG. 3. The media player class represents the media player 142 that is instantiated by the proxy application 144, and includes functionality to control playback of recorded media content and/or streaming media content on the client device. The playback of the recorded media content, and playback of the streaming media content, are both different instantiations of the media player class.

In the example communication sequence 1800, the client device application 1802 initiates a get media player object message 1808 to the media player object 1804, which returns the media player return object 1810 to the client device application. The client device application then communicates a prepare to play content program object message 1812 to the media player object 1804. The media player can then setup playback or streaming logistics 1814 and communicate an ok return object 1816 to the client device application. The client device application then communicates a get movie player type object message 1818 to the media player object 1804, which in turn, communicates an allocation object message to the MP controller 1806. The media player object 1804 also communicates an init with content URL object message 1822 to the MP controller, and the media player object responds to the client device application with a movie player return object 1824. The client device application communicates a play object message 1826 to the MP controller 1806, as well as a release movie player object message 1828 to the media player 1804. The media player then communicates the release object message 1830 to the MP controller 1806.

REST API Spec

An API specification is described herein as a Representational State Transfer (REST) software architecture. The REST API specification includes the API definitions of the object model classes that are described with reference to the client object model 300 shown in FIG. 3. The REST API specification includes Resource URIs (uniform resource identifiers), which are implemented as:

Content Directory URI: (refers to programs that are available for download)
http://{portal-server}/programs/contentdirectory

Program Metadata URI:
http://{portal-server}/programs/{program-id}

Set Transcode Mode:
http://{content-server}/content/settranscodemode?m=<CO/NONE>

Transcode Priority URI:
http://{content-server}/content/{program-id}

Domain URI:
http://{domain-server}/domain/{device-id}

Content Control Profile URI:
http://{domain-server}/domain/contentControlProfile

Mover Discovery and Name Resolution

As noted above, the media server is also referred to herein as the Mover. The Mover Runtime environment and software architecture are shown in FIGS. 1 and 2. In an embodiment of a Mover application, the Mover serves as the portal server, the content server, as well as the domain server. Prior to launching any of the Resource URIs above, the client device discovers the Mover's server name that can be used to resolve to the Mover IP address, as described with reference to FIG. 8. The Mover supports the Multicast DNS (mDNS) for the name discovery and IP address resolution mechanism. The mDNS protocol lets the client device discover the Mover by obtaining its fully-qualified name (FQN) and its IP address. First the client multicasts a query looking for the Mover, and then the Mover's mDNS server responds to the request by providing the FQN and the IP address. With that, the client device builds its name resolution table, and when the Mover's FQN is used in the HTTP URI, the message will be sent to the Mover correctly.

Mover Status Update Notification

The mDNS protocol also supports event notifications. The Mover uses this mechanism to notify the client devices when the status changes in some way. The scope of status updates includes the default ratings PIN, the default rating ceiling, the default content advisory settings and channel blocks, the content metadata and repository, and a notification that user intervention is required via the Mover local Web configuration page (for example, that flash memory needs configuration). Note that the ratings related status data is protected. If ratings information of content information has changed, the client devices would normally launch the relevant resource URI.

Method Overview

Methods include:

| | | |
|---|---|---|
| Resource (next | | |
| line): Method | Returns | HTTP Return Codes |

http://{portal-server}/programs/{program-id}

| | | |
|---|---|---|
| GET | PROGRAM metadata | 200 (OK), 404 |

http://{portal-server}/programs/contentdirectory

| | | |
|---|---|---|
| GET | Content Directory List | 200 (OK), 404 |

http://{content-server}/content/settranscodemode

| | |
|---|---|
| POST | 200 (OK), 404 |

http://{content-server}/content/{program-id}

| | |
|---|---|
| GET | 200 (OK), 404, 405 |

http://{domain-server}/domain/{device-id}

| | |
|---|---|
| PUT | 200 (OK), 401, 402, 403, 404 |

http://{domain-server}/domain/{device-id}

| | |
|---|---|
| DELETE | 200 (OK), 404 |

http://{domain-server}/domain/contentControlProfile

| | | |
|---|---|---|
| GET | A protected data blob | 200 (OK), 404 |
| | describing the subject | |

Representation MIME Types

The following mime types are used for resource representation:

text/xml for metadata representations;

video/mpeg for video;

application/vnd.motorola.iprm for IPRM encrypted video; and

application/x-dtcpl for DTCP encrypted video.

### ABBREVIATIONS USED

The following abbreviations are used:

{portal-server} Portal Server that implements the RESTful web service.

{content-server} Server for accessing content payload.

{domain-server} The server that enforces domain control rules.

{streaming-server} The server that provides HLS streaming.

Content Directory

Description: The content directory URI provides the list of programs that are currently in the Mover database. This is further described above with reference to the media server object 1004 (FIG. 10) that references the REST API content directory URI 1012, and with reference to the media server object 1104 (FIG. 11) that references the REST API content directory URI 1120, which provides the list of programs currently in the media server database.

Sequence Number: The sequenceNumber element in the response message indicates to the client application whether the content list is changed from last time. A new sequence number indicates a change.

Transcoding Status: The status element indicates one of the four transcoding status: ready (for download or streaming), being processed (i.e. being transcoded), pending (for processing) and not available (e.g. ratings blocked, or bad content). Note that all directory items returned in a response that are marked pending are returned in transcoder queue (priority) order, with the first listing at the highest priority, meaning, next to be transcoded.

Content Usage: The usageAllowed element signals what kinds of use cases are allowed for the content. The table below specifies mapping between the usageAllowed metadata value and the client use cases allowed:

| <usageAllowed> | Use Case(s) allowed |
|---|---|
| stream | Streaming |
| move | Streaming, Move |
| copy | Streaming, Copy |

Content Ratings: The content ratings values are listed below. A program can assume one and only one rating. Note that these values are defined by the MPAA and the TV Parental Guidelines Monitoring Board. The content rating values include Not Rated, TV-Y, TV-Y7, TV-G, G, TV-PG, PG, PG-13, TV-14, TV-MA, R, NC-17, and Adult.

Parental Control Categories: The values for parental control categories are listed below. A program can assume one or multiple categories. Note that these values are defined by the TV Parental Guidelines Monitoring Board. The parental control categories values include Adult Situation, Brief Nudity, Sexual Situations, Rape, Nudity, Strong Sexual, Language, Strong Language, Graphic Language, Explicit Language, Fantasy Violence, Mild Violence, Violence, and Graphic Violence.

URI and Defined Methods:

| | |
|---|---|
| URI | http://{portal-server}/programs/contentdirectory |
| METHODS | GET |
| RETURN | 200 OK & XML (program list), 404 (Not Found) |
| VALUES | |

GET Implementation:

| GET http://{portal-server}/programs/contentdirectory | |
|---|---|
| RETURNS: | {list of programs} |

<?xml version=″1.0″ encoding=″UTF-8”?>
<moverContent>
<moverProtocolVersion>1.0</moverProtocolVersion>
<sequenceNumber>102</sequenceNumber>

<program channel=″53044″ ... > ... < /program >

...

</moverContent>

The example below shows a list of two content items, one with program-id TOD55341 and the other with TOD55342. The first program comes with two content URLs, a type 1 and a type 2. The variant attribute corresponds to the device type (see the device registration for details). The client application is recommended to use the URL that matches its device type or the content playback might fail or present a suboptimal experience. The icon element specifies where to get the program thumbnail. There are two icon elements in the first program, intended to match the best usage for a type 1 and type 2 device respectively. The height element and the width element show example values.

GET http://{portal-server}/programs/contentdirectory
RETURNS:
<?xml version=“1.0” encoding=“UTF-8”?>
<moverContent>
<moverProtocolVersion>1.0</moverProtocolVersion>
<sequenceNumber>102</sequenceNumber>
<program channel=“53044” channelName=“NBC” program-id=“TOD55341” showtype=“Series”
start=“2009-05-29T18:01:00Z” stop=“2009-05 29T19:00:00Z”>
<seriesName lang=“”>Northern Exposure</seriesName>
<programName lang=“”>A Wing and a Prayer</programName>
<status>ready</status>
<usageAllowed>stream</usageAllowed>
<rating>PG</rating>
<parentalControlCategory>

<contentCategory>Language</contentCategory>

</parentalControlCategory>
<icon height=“32” src=“http://192.168.4.12:7001/portalaccess/images/aptn_logo_94x90.jpg”
width=“32”/>
< icon height=“48” src=“http://192.168.4.12:7001/portalaccess/images/aptn_logo_194x190.jpg”
width=“48”/>
<content-url href=“http://192.168.4.12/content/TOD55341.mp4” variant=“type 1”
protectionType=“IPRM” filesize=“12345678” contentID=“xyz001” />
<content-url href=“http://192.168.4.12/content/TOD55341-1.mp4” variant=“type 2”
rotectionType=“IPRM” filesize=“12345678” contentID=“xyz001” />
</program>
<program channel=“53044” channelName=“NBC” program-id=“TOD55342” showtype=“Series”
start=“2009-05-29T19:01:00Z”stop=“2009-05-29T20:00:00Z”>
<seriesName lang=“”>Chuck</seriesName>
<programName lang=“”>The Missing Old Man</programName>
<status>pending</status>
<usageAllowed>copy</usageAllowed>
<rating>R</rating>
<parentalControlCategory>

<contentCategory>Violence</contentCategory>
<contentCategory>Language</contentCategory>
<contentCategory>Nudity</contentCategory>

</parentalControlCategory>
<icon height=“32” src=“http://192.168.4.12:7001/portalaccess/images/aptn_logo_94x90.jpg”
width=“32”/>
<content-url href=“http://content-server/content/TOD55342” variant=“type 1”
protectionType=“DTCP-IP” filesize=“12345678” contentID=“xyz002” />
</program>
</moverContent>

Program Metadata

Description: The program metadata URI is a pre-defined URI which can be used to download the detailed program representation of any program using the program-id. This is further described above with reference to the content program object 1206 (FIG. 12) that references the REST API program metadata URI 1214, which can be used to download the detailed program representation of any program using the program-id. The URI and Defined Methods:

| | |
|---|---|
| URI | http://{portal-server}/programs/{program-id} |
| METHODS | GET |
| RETURN | 200 OK & XML (program metadata), 404 (Not Found), |
| VALUES | |

GET Implementation: See Example. Two examples are shown below. Example 1 shows the case where the metadata is protected and base64 encoded, and the second example shows clear metadata. In order to produce the clear metadata, the client app must use the <protectionType> and apply the right scheme to it.

| GET http://{portal-server}/programs/ TOD55341 | |
|---|---|
| RETURNS: | (metadata for a single program) |

<?xml version=“1.0” encoding=“UTF-8”?>
<moverContent>
<moverProtocolVersion>1.0</moverProtocolVersion>
<protectedMetadata>

{a base64 encoded binary data blob}

</protectedMetadata>
</moverContent>

GET http://{portal-server}/programs/ TOD55341

| | |
|---|---|
| RETURNS: | (metadata for a single program) |

<?xml version=“1.0” encoding=“UTF-8”?>
<moverContent>
<moverProtocolVersion>1.0</moverProtocolVersion>
<program channel=“53044” channelName=“NBC”
program-id=“TOD55341” showType=“Series”
start=“2009-05-29T18:01:00Z” stop=“2009-05-29T19:00:00Z”
closeCaptioned=“true”>
<seriesName lang=“”>Northern Exposure</seriesName>
<desc lang=“”>Maggie hires Maurice to help her build an ultralight, then
fires him when he gets bossy; Ed betrays Ruth-Annes confidence.</desc>
<credits>
<actor>Rob</actor>
<actor>Steve</actor>
<director>Mohan</director>
<director>Wendelk/director>
<producer>Dev</producer>
</credits>
<audio present=“yes” stereo=“yes” />
<episode-num system=“xmltv_ns”>77720</episode-num>
</program>
</moverContent>

Set Transcode Mode

URI and Defined Methods. Description: This URI is a command to the content server, indicating whether it should transcode the Copy Once content or not, in an automatic fashion.

| | |
|---|---|
| URI | http://{content-server}/content/settranscodemode?m=<CO/NO> |
| METHODS | POST |
| RETURN | 200 OK, 404 (fail) |
| VALUES | |

GET Implementation: Parameter CO: Transcode Copy Once content automatically. Parameter NO: Do NOT transcode Copy Once content automatically; rather, transcode each such content item on request.

GET http://{content-server}/content/transcodemode?m=<CO/NO>
RETURNS:

Transcode Priority

URI and Defined Methods:

| | |
|---|---|
| URI | http://{content-server}/content/{program-id} |
| METHODS | GET |
| RETURN | 200 (Priority Raised), 404 (Not Found), |
| VALUES | 405 (Failed to raise Priority) |

Return Value Notes: The return value 200 indicates the priority of the requested program has been raised. The return value 404 indicates program not found. The return value 405 indicates the priority of the requested program cannot be raised. GET Implementation:

GET http://{content-server}/content/{program-id}
RETURNS:

Device Registration
Descriptions: To register a new client device to the Mover domain, a PUT message is sent to the ‘domain’ URI with the device-id appended to the end. The body of the PUT method includes the data elements defined below. URI and Defined Methods:

| | |
|---|---|
| URI | http://{domain-server}/domain/{device-id} |
| METHODS | PUT |
| RETURN | 200 OK, 401 (Ill-formed body), 402 (Duplicate |
| VALUES | device ID), 403 (protection type not supported), |
| | 404 (Exceeds maximum number of devices allowed), |

PUT Implementation

PUT http://{domain-server}/domain/{device-id}
<?xml version=″1.0″ encoding=″UTF-8”?>
<clientDevice>
<deviceID>{device-id}</deviceID>
<deviceName>{device-name}</deviceName>
<deviceType>{device-type}</deviceType>
<protectionType>{device-protection-type}</protectionType>
</clientDevice>

PUT Data Elements:
{device-id}: The device ID is a base64-encoded binary string that uniquely identifies the client device according to its DRM certificate. For a device with IPRM certificates, it has a 48-bit Host ID, and for a device with DTCP certificates, it has a 40-bit Device ID.
{device-name}: The device name is a user-friendly string, determined by the client's user. All printable characters and blank spaces are allowed.
{device-type}: The device type field signals the type of user device, i.e., type 1 or type 2. A type 1 device would support half-VGA resolution H.264 baseline profile video coding, AAC audio coding, and an MP4 file container. A type 2 device would support type 1 content as well as VGA resolution H.264 main profile video coding, AAC audio coding, and an MP4 file container. In either type, the MP4 file is an ISO/IEC 14496 standard part 14 format, further qualified to guarantee that the moov box is located before any mdat box, and there will be only one mdat box in the whole content file. This qualification allows progressive download support.
{device-protection-type}: The device protection type signals the type of security being supported by the device, e.g., IPRM or DTCP-IP.

### Example

PUT http://{domain-server}/domain/{aBase64EncodedString}
<?xml version=″1.0″ encoding=″UTF-8”?>
<clientDevice>
<deviceID>{aBase64EncodedString}</deviceID>
<deviceName>Library PC</deviceName>
<deviceType>type 1</deviceType>
<protectionType>DTCP-IP</protectionType>
</clientDevice>

Device De-Registration
Description: To de-register a client device from the Mover domain, a DELETE message is sent to the ‘domain’ URI with the device-id appended to the end. URI and Defined Methods:

| | |
|---|---|
| URI | http://{domain-server}/domain/{device-id} |
| METHODS | DELETE |
| RETURN | 200 OK, 404 (Not Found) |
| VALUES | |

DELETE Implementation

### Example

DELETE http://{domain-server}/domain/{aBase64EncodedString}

Content Control Profile
Description: The Content Control Profile URI retrieves the Mover content control profile, including the rating's ceiling, the content advisory information, the PIN and the channel block information. URI and Defined Methods:

| | |
|---|---|
| URI | http://{domain-server}/domain/contentControlProfile |
| METHODS | GET |
| RETURN | 200 OK & XML (status metadata), 404 (Not Found) |
| VALUES | |

### Examples

The example below shows a GET request and the response XML metadata. Note that the metadata is encrypted with a secret key and the client needs to decrypt it first and then parse out the detailed data items. The <profileProtectionType> data item signals what kind of protection scheme is applied.

GET http://{domain-server}/domain/contentControlProfile

| | |
|---|---|
| RETURNS: | (protected metadata of the Mover status update) |

<?xml version=“1.0” encoding=“UTF-8”?>
<contentControlProfile>

<moverProtocolVersion>1.0</moverProtocolVersion>
<sequenceNumber>2475</sequenceNumber>
<profileProtectionType>PPT-1</profileProtectionType >
<profileData>

{a base64 encoded binary data blob}

</profileData>

</contentControlProfile>

### Status Metadata Examples

The example below shows a set of content control profile after it's been unscrambled.

<?xml version=“1.0” encoding=“UTF-8”?>
<contentControlProfile>

<moverProtocolVersion>1.0</moverProtocolVersion>
<sequenceNumber>2475</sequenceNumber>
<PIN>1234</PIN>
<contentBlocking>

<rating>PG-13</ rating>
<parentalControlCategory>

<contentCategory>Violence</contentCategory>
<contentCategory>Rape</contentCategory>
<contentCategory>Language</contentCategory>
<contentCategory>Nudity</contentCategory>

</parentalControlCategory>
<channelBlock>

<channel>73</channel>
<channel>103</channel>
<channel>765</channel>

</channelBlock>

</contentBlocking>
</contentControlProfile>

XML Schemas

Content Directory Schema

Content Directory Schema

<?xml version=″1.0″ encoding=″utf-8″?>
<xs:schema xmlns:xs=″http://www.w3.org/2001/XMLSchema″
xmlns:wmh=″http://www.wmhelp.com/2003/eGenerator″ elementFormDefault=″qualified″>

<xs:element name=″moverContent″>

<xs:element name=″moverProtocolVersion″ type=″xs:string″/>
<xs:element name=″sequenceNumber″ type=″xs:string″/>
<xs:complexType>

<xs:sequence>

<xs:element ref=″program″ maxOccurs=″unbounded″/>

</xs:sequence>

</xs:complexType>

</xs:element>
<xs:element name=″program″>

<xs:complexType>

<xs:attribute name=″channel″ type=″xs:string″ use=″required″/>
<xs:attribute name=″channelName″ type=″xs:string″ use=″required″/>
<xs:attribute name=″program-id″ type=″xs:string″ use=″required″/>
<xs:attribute name=″showtype″ type=″xs:string″/>
<xs:attribute name=″start″ type=″xs:string″ use=″required″/>
<xs:attribute name=″stop″ type=″xs:string″ use=″required″/>
<xs:element ref=″seriesName″/>
<xs:element ref=″programName″/>
<xs:element ref=″status″/>
<xs:element ref=″usageAllowed″/>
<xs:element ref=″rating″/>
<xs:element ref=″parentalCotrolCategory″/>
<xs:sequence>

<xs:element ref=″icon″/>
<xs:element ref=″content-url″ maxOccurs=″unbounded″ minOccurs=″1″/>

</xs:sequence>

</xs:complexType>
</xs:element>
<xs:element name=″seriesName″>

<xs:complexType>

<xs:simpleContent>

<xs:extension base=″xs:string″>

<xs:attribute name=″lang″ type=″xs:string″ use=″required″/>

</xs:extension>

</xs:simpleContent>

</xs:complexType>

</xs:element>
<xs:element name=″programName″>

<xs:complexType>

<xs:simpleContent>

<xs:extension base=″xs:string″>

<xs:attribute name=″lang″ type=″xs:string″ use=″required″/>

</xs:extension>

</xs:simpleContent>

</xs:complexType>

</xs:element>
<xs:element name=″icon″>

<xs:complexType>

<xs:attribute name=″height″ type=″xs:string″ use=″required″/>
<xs:attribute name=″src″ type=″xs:string″ use=″required″/>
<xs:attribute name=″width″ type=″xs:string″ use=″required″/>

</xs:complexType>

</xs:element>
<xs:element name=″content-url″>

<xs:complexType>

```
<xs:attribute name=″href″ type=″xs:string″ use=″required″/>
<xs:attribute name=″variant″ type=″xs:string″ use=″required″/>
<xs:attribute name=″protectionType″ type=″xs:string″ use=″required″/>
  <xs:attribute name=″filesize″ type=″xs:string″/>
  <xs:attribute name=″contentID″ type=″xs:string″/>
```

</xs:complexType>

```
  </xs:element>
  <xs:element name=″status″>
```

<xs:simpleType>
<xs:restriction base=”xs:string”>

```
  <xs:enumeration value=”ready”/>
  <xs:enumeration value=”being processed”/>
  <xs:enumeration value=”pending”/>
  <xs:enumeration value=”toBeSelected”/>
  <xs:enumeration value=”not available”/>
```

</xs:restriction>
</xs:simpleType>

```
  </xs:element>
  <xs:element name=”usageAllowed”/>
```

<xs:simpleType>
<xs:restriction base=”xs:string”>

```
  <xs:enumeration value=”stream”/>
  <xs:enumeration value=”copy”/>
  <xs:enumeration value=”move”/>
```

</xs:restriction>
</xs:simpleType>

```
  </xs:element>
  <xs:element name=”protectionType”/>
```

<xs:simpleType>
<xs:restriction base=”xs:string”>

```
  <xs:enumeration value=”IPRM”/>
  <xs:enumeration value=”DTCP-IP”/>
</xs:restriction>
```

</xs:simpleType>

```
  </xs:element>
  <xs:element name=″rating″>
```

<xs:simpleType>
<xs:restriction base=”xs:string”>

```
<xs:enumeration value=”Not Rated”/>
  <xs:enumeration value=”TV-Y”/>
  <xs:enumeration value=”TV-Y7”/>
  <xs:enumeration value=”TV-G”/>
  <xs:enumeration value=”G”/>
  <xs:enumeration value=”TV-PG”/>
  <xs:enumeration value=”PG”/>
  <xs:enumeration value=”PG-13”/>
  <xs:enumeration value=”TV-14”/>
  <xs:enumeration value=”TV-MA”/>
  <xs:enumeration value=”R”/>
  <xs:enumeration value=”NC-17”/>
  <xs:enumeration value=”Adult”/>
</xs:restriction>
```

```
  </xs:simpleType>
</xs:element>
<xs:element name=″contentCategory″>
  <xs:simpleType>
```

<xs:restriction base=”xs:string”>

<xs:enumeration value=”Adult Situation”/>
<xs:enumeration value=”Brief Nudity”/>
<xs:enumeration value=”Sexual Situations”/>
<xs:enumeration value=”Rape”/>
<xs:enumeration value=”Nudify”/>
<xs:enumeration value=”Strong Sexual”/>
<xs:enumeration value=”Language”/>
<xs:enumeration value=”Strong Language”/>
<xs:enumeration value=”Graphic Language”/>
<xs:enumeration value=”Explicit Language”/>
<xs:enumeration value=”Fantasy Violence”/>
<xs:enumeration value=”Mild Violence”/>
<xs:enumeration value=”Violence”/>
<xs:enumeration value=”Graphic Violence”/>

</xs:restriction>

</xs:simpleType>

```
  </xs:element>
  <xs:element name=”parentalControlCategory”>
```

<xs:complexType>
<xs:sequence>

<xs:element ref=”contentCategory” maxOccurs=”14”/>

</xs:sequence>
</xs:complexType>

</xs:element>

</xs:schema>

Program Detail Schemas

Program Detail Schema - protected

<?xml version=″1.0″ encoding=″utf-8″?>
<xs:schema xmlns:xs=″http://www.w3.org/2001/XMLSchema″
xmlns:wmh=″http://www.wmhelp.com/2003/eGenerator″
elementFormDefault=″qualified″>

<xs:element name=″moverContent″>

<xs:element name=″moverProtocolVersion″ type=″xs:string″/>
<xs:complexType>

<xs:element name=″protectionType″
type=″xs:string″/>
<xs:element name=″ protectedMetadata ″
type=”xs:base64Binary”/>

</xs:complexType>

</xs:element>

</xs:schema>

Program Detail Schema - clear

<?xml version=“1.0” encoding=“utf-8”?>
<xs:schema xmlns:xs=“http://www.w3.org/2001/XMLSchema”
xmlns:wmh=“http://www.wmhelp.com/2003/eGenerator” elementFormDefault=“qualified”>

<xs:element name=“moverContent”>

<xs:element name=“moverProtocolVersion” type=“xs:string”/>
<xs:complexType>
<xs:element ref=“program”/>
</xs:complexType>

</xs:element>
<xs:element name=“program”>

```
<xs:complexType>
  <xs:attribute name=“channel” type=“xs:string” use=“required”/>
  <xs:attribute name=“channelName” type=“xs:string” use=“required”/>
  <xs:attribute name=“program-id” type=“xs:string” use=“required”/>
  <xs:attribute name=“showType” type=“xs:string” use=“required”/>
  <xs:attribute name=“start” type=“xs:string” use=“required”/>
  <xs:attribute name=“stop” type=“xs:string” use=“required”/>
  <xs:attribute name=“closeCaptioned” type=“xs:string” use=“required”/>
  <xs:element ref=“seriesName”/>
  <xs:element ref=“desc”/>
  <xs:element ref=“credits”/>
  <xs:element ref=“audio”/>
  <xs:element ref=“episode-num”/>
</xs:complexType>
```

</xs:element>
<xs:element name=“seriesName”>

<xs:complexType>

<xs:simpleContent>

<xs:extension base=“xs:string”>

<xs:attribute name=“lang” type=“xs:string” use=“required”/>

</xs:extension>

</xs:simpleContent>

</xs:complexType>

</xs:element>
<xs:element name=“desc”>

<xs:complexType>

<xs:simpleContent>

<xs:extension base=“xs:string”>

<xs:attribute name=“lang” type=“xs:string” use=“required”/>

</xs:extension>

</xs:simpleContent>

</xs:complexType>

</xs:element>
<xs:element name=“credits”>

<xs:complexType>

<xs:sequence>

<xs:element ref=“actor”/>
<xs:element ref=“director”/>
<xs:element ref=“producer”/>

</xs:sequence>

</xs:complexType>

</xs:element>
<xs:element name=“actor” type=“xs:string”/>
<xs:element name=“director” type=“xs:string”/>
<xs:element name=“producer” type=“xs:string”/>
<xs:element name=“audio”>

<xs:complexType>
<xs:attribute name=“present” type=“xs:string” use=“required”/>
<xs:attribute name=“stereo” type=“xs:string” use=“required”/>
</xs:complexType>

</xs:element>
<xs:element name=“episode-num”>

<xs:complexType>

<xs:simpleContent>

<xs:extension base=“xs:string”>

<xs:attribute name=“system” type=“xs:string” use=“required”/>

</xs:extension>

</xs:simpleContent>

</xs:complexType>

</xs:element>

</xs:schema>

Device Registration Schema

Device Registration Schema

<?xml version=″1.0″ encoding=″utf-8″?>
<xs:schema xmlns:xs=″http://www.w3.org/2001/XMLSchema″
xmlns:wmh=″http://www.wmhelp.com/2003/eGenerator″
elementFormDefault=″qualified″>

<xs:element name=”clientDevice”>
<xs:complexType>

<xs:element name=″deviceID″ type=″xs:base64Binary″
use=″required″/>
<xs:element name=″deviceName″ type=″xs:string″/>
<xs:element name=”deviceType”/>
<xs:simpleType>

<xs:restriction base=”xs:string”>

<xs:restriction value=”type 1”/>
<xs:restriction value=”type 2”/>

</xs:restriction>

</xs:simpleType>

```
  </xs:element>
  <xs:element ref=”protectionType”/>
</xs:complexType>
```

</xs:element>
</xs:schema>

Content Control Profile Schemas

Content Control Profile Schema - protected

<?xml version=″1.0″ encoding=″utf-8″?>
<xs:schema xmlns:xs=″http://www.w3.org/2001/XMLSchema″
xmlns:wmh=″http://www.wmhelp.com/2003/eGenerator″
elementFormDefault=″qualified″>

<xs:element name=”contentControlProfile”>

<xs:element name=″moverProtocolVersion″ type=″xs:string″/>
<xs:element name=″sequenceNumber″ type=″xs:string″/>
<xs:element name=″profileProtectionType″ type=″xs:string″/>
<xs:element name=″profileData″ type=”xs:base64Binary”/>

</xs:element>

</xs:schema>

Status Update Schema - clear

<?xml version=″1.0″ encoding=″utf-8″?>
<xs:schema xmlns:xs=″http://www.w3.org/2001/XMLSchema″
xmlns:wmh=″http://www.wmhelp.com/2003/eGenerator″
elementFormDefault=″qualified″>

<xs:element name=″contentControlProfile″>

<xs:element name=″moverProtocolVersion″ type=″xs:string″/>
<xs:element name=″sequenceNumber″ type=″xs:string″/>
<xs:complexType>

<xs:sequence>

<xs:element name=”PIN” type=”xs:string”/>
<xs:element ref=”contentBlocking”/>

</xs:sequence>

</xs:complexType>

</xs:element>
<xs :element name=”contentBlocking”>

<xs:complexType>

<xs:sequence>

<xs:element ref=”rating”/>
<xs:element ref=”parentalControlCategory”/>
<xs:element ref=”channelBlock”/>

</xs:sequence>

</xs:complexType>

</xs:element>
<xs:element name=”channelBlock”>

<xs:complexType>

<xs:sequence>

<xs:element name=”channel” type=”xs:string”
maxOccurs=”unbounded”/>

</xs:sequence>

</xs:complexType>

</element>

</xs:schema>

Although embodiments of secure progressive download for media content playback have been described in language specific to features and/or methods, the subject of the appended claims is not necessarily limited to the specific features or methods described. Rather, the specific features and methods are disclosed as example implementations of secure progressive download for media content playback.

1. A method, comprising:
receiving media content from a media server, the media content encrypted and formatted by the media server for playback by a media player on a client device;
storing segments of the media content as encrypted media content on the client device;
requesting an encryption key from a key server;
receiving the encryption key from the key server; and
storing the encryption key on the client device to decrypt the encrypted media content for playback by the media player.

2. The method as recited in claim 1, further comprising:
receiving a request for the media content from the media player;
decrypting the encrypted media content with the encryption key; and
communicating decrypted media content for playback by the media player.

3. The method as recited in claim 2, wherein:
said decrypting the encrypted media content comprises decrypting the stored segments of the media content; and
said communicating the decrypted media content comprises communicating the decrypted segments of the media content as a progressive download to the media player.

4. The method as recited in claim 1, wherein the encrypted media content is received from the media server via wireless communication.

5. The method as recited in claim 1, wherein the client device is a mobile device comprising the media player configured to playback the media content for display on the mobile device.

6. The method as recited in claim 1, wherein the media server:
receives the media content from a television client device as originally encrypted media content;
decrypts the originally encrypted media content;
formats the decrypted media content for playback by the media player on the client device; and
re-encrypts the formatted media content for communication to the client device as the encrypted media content.

7. The method as recited in claim 1, further comprising:
receiving encryption key request parameters from the media server, and wherein the encryption key is requested from the key server utilizing the encryption key request parameters.

8. The method as recited in claim 5, further comprising:
authenticating the client device to the media server; and
instantiating the media player to playback the media content at the client device.

9. A method, comprising:
receiving a request for media content from a proxy application of a client device;
receiving the media content from a television client device as encrypted media content;
decrypting the encrypted media content;
formatting the media content for playback by a media player on the client device;
requesting an encryption key from a key server;
receiving the encryption key from the key server; and
re-encrypting the media content with the encryption key for communication to the proxy application as encrypted, formatted media content.

10. The method as recited in claim 9, further comprising:
communicating the encrypted, formatted media content as media content segments to the proxy application of the client device, wherein the proxy application:
requests the encryption key from the key server;
receives the encryption key from the key server; and
stores the encryption key on the client device to decrypt the encrypted, formatted media content for playback by the media player.

11. The method as recited in claim 9, further comprising:
communicating the encrypted, formatted media content as media content segments to the proxy application as a progressive download of the media content for decryption by the proxy application and playback by the media player on the client device.

12. The method as recited in claim 9, further comprising:
communicating the encrypted, formatted media content to the proxy application of the client device via wireless communication, and wherein the client device is a mobile device configured to display the media content.

13. The method as recited in claim 9, wherein said formatting the media content comprises:
transcoding high definition media content to a VGA format for playback by the media player on the client device.

14. A client device, comprising:
a media player configured to control playback of media content on the client device;
a memory and a processor to implement a proxy application configured to:
receive the media content from a media server, the media content encrypted and formatted by the media server for playback by the media player;
request an encryption key to decrypt the encrypted media content for playback by the media player;
receive the encryption key from a key server; and
data storage configured to store the encryption key and segments of the media content as encrypted media content on the client device.

15. The client device as recited in claim 14, wherein the proxy application is further configured to:
receive a request for the media content from the media player;
decrypt the encrypted media content with the encryption key; and
communicate decrypted media content for playback by the media player.

16. The client device as recited in claim 14, wherein the proxy application is further configured to:
decrypt the stored segments of the media content with the encryption key; and
communicate decrypted segments of the media content to the media player.

17. The client device as recited in claim 14, wherein the client device is configured to receive the encrypted media content from the media server via wireless communication.

18. The client device as recited in claim 14, wherein the proxy application is configured to receive the media content from the media server as encrypted, formatted media content, and wherein the media server:
receives the media content from a television client device as originally encrypted media content;
decrypts the originally encrypted media content;
formats the decrypted media content for playback by the media player on the client device; and
re-encrypts the formatted media content for communication to the client device as the encrypted, formatted media content.

19. The client device as recited in claim 14, wherein the proxy application is further configured to:
receive encryption key request parameters from the media server; and
request the encryption key from the key server utilizing the encryption key request parameters.

20. The client device as recited in claim 14, wherein the proxy application is further configured to:
authenticate the client device to the media server; and
instantiate the media player to playback the media content at the client device.
